(19) United States
(12) Patent Application Publication
(10) Pub. No.: US 2024/0424477 A1
(43) Pub. Date: Dec. 26, 2024

(54) SYSTEM AND DEVICES FOR REMOVAL OF CONTAMINATES

(71) Applicant: BOARD OF REGENTS, THE UNIVERSITY OF TEXAS SYSTEM, Austin, TX (US)

(72) Inventors: Manish KUMAR, Austin, TX (US); Sophie DE RESPINO, Austin, TX (US)

(21) Appl. No.: 18/705,820

(22) PCT Filed: Oct. 31, 2022
(86) PCT No.: PCT/US2022/048457

§ 371 Date: Apr. 29, 2024

Related U.S. Application Data
(60) Provisional application No. 63/273,825, filed on Oct. 29, 2021.

(51) Int. Cl. B01J 20/24; B01D 39/04; B01J 20/28; C02F 1/28; C02F 101/32; C02F 101/36

(52) U.S. Cl. CPC B01J 20/24; B01D 39/04; B01J 20/28028; C02F 1/288; B01D 2239/0428; B01D 2239/0442; B01D 2239/1225; C02F 1/286; C02F 2101/32; C02F 2101/36; C02F 2303/04

(57) ABSTRACT

Disclosed are methods, devices, systems, and filter media for the removal of contaminants (e.g., oils, per- and poly-fluoroalkyl substances (PFAS), and/or microbes) from a fluid. The filter media can comprise a fiber (e.g., a hydrophobic fiber or an oleophilic fiber, such as Ceiba pentandra fibers), and a binder (e.g., an extract from Moringa oleifera (MO) seeds). The filter media, systems, and devices described herein can be used to remove contaminants (e.g., oils, per- and polyfluoroalkyl substances (PFAS), and/or microbes) from a fluid.

### CROSS-REFERENCE TO RELATED APPLICATIONS

This application claims benefit of U.S. Provisional Application No. 63/273,825 filed Oct. 29, 2021, which is hereby incorporated herein by reference in its entirety.

### STATEMENT REGARDING FEDERALLY SPONSORED RESEARCH OR DEVELOPMENT

This invention was made with government support under Grant No. DGE1828974 and Grant No. CBET2022971 awarded by the National Science Foundation. The government has certain rights in the invention.

### TECHNICAL FIELD

This application relates generally to systems and devices directed to the treatment and filtration of contaminated solutions, in particular systems and devices for removing oils, per- and polyfluoroalkyl substances, and/or microbes from water.

### BACKGROUND

Filtration is a widely used water treatment technology, and is required by the U.S. Environmental Protection Agency (EPA) for almost all municipal waters. Filtration can be employed to remove particles, organic and inorganic matter from water. It is often coupled with other treatment steps, such as coagulation/flocculation and disinfection, to further refine water quality. Filtration technologies generally come in two forms: media filtration (e.g., passing a fluid through a particulate stationary phase such as sand and granular activated carbon) and membrane filtration, each with its own advantages and drawbacks.

Media filtration is commonly employed to reduce turbidity and suspended solids. Slow sand and rapid sand filtration (SSF, RSF, respectively), are often simpler and easier to operate when compared to membrane filtration. SSF is among the most favorable point-of-use water treatment technologies for use in developing countries, but its large footprint needed for municipal applications makes it less ideal to treat large volumes of water in a timely manner. RSF can achieve higher loading rates, but it does not provide sufficient disinfection for drinking water treatment, so water must undergo further disinfection.

Membrane filtration is an attractive technology due to its ability to remove a wide range of contaminants based on the membrane pore size, such as bacteria, viruses, and ions. They are utilized in a variety of applications, such as for produced water treatment, desalination, and in the pharmaceutical industry. However, one of the most significant drawbacks to membranes are their high propensity for biofouling as microbes and organics accumulate on the surface. Biofouling effects membrane efficiency by decreasing permeate production, decreasing salt rejection, and increasing energy consumption. These operational issues lead to increased costs associated with membrane cleaning, decreased lifetime, replacement costs, and increased energy consumption. Accordingly, sustainable modifications to media filtration and pretreatments for membrane technologies are necessary to improve current technology and mitigate biofouling issues, respectively.

### SUMMARY

Provided herein are filter media, systems, and devices that can be used to remove contaminants (e.g., oils, per- and polyfluoroalkyl substances (PFAS), and/or microbes) from a fluid.

For example, provided herein is filter media that comprises a hydrophobic fiber and a microbial binding material disposed thereon. The microbial binding material can comprise a protein extracted from Moringa oleifera seeds (e.g., Moringa oleifera chitin-binding protein (MOCBP), Moringa oleifera coagulant protein (MO2.1), isoforms thereof, or a combination thereof). The microbial binding material can be electrostatically disposed on the hydrophobic fiber, hydrophobically disposed on the hydrophobic fibers, or any combination thereof. In some embodiments, the hydrophobic fiber can be oleophilic. In some embodiments, the hydrophobic fiber can comprise a natural fiber, such as kapok fibers, silk fibers, milkweed fibers, or combinations thereof.

Also provided is filter media that can be used to decrease the concentration of a per- and polyfluoroalkyl substance (PFAS) in a fluid comprising a fibrous substrate and a cationic binder disposed thereon. The cationic binder can comprise a cationic protein, such as a cationic protein extracted from Moringa oleifera seeds (e.g., Moringa oleifera chitin-binding protein (MOCBP), Moringa oleifera coagulant protein (MO2.1), isoforms thereof, or a combination thereof). The fibrous substrate can comprise, for example, hydrophobic fibers. In some embodiments, the fibrous substrate can comprise oleophilic fibers. In some embodiments, the fibrous substrate can comprise natural fibers, such as kapok fibers, silk fibers, milkweed fibers, or combinations thereof.

Also provided are filters comprising the filter media described herein disposed within a housing, as well as systems for decreasing a concentration of a contaminant in a fluid comprising the filters described herein.

The filter media, systems, and devices described herein can be used to remove contaminants (e.g., oils, per- and polyfluoroalkyl substances (PFAS), and/or microbes) from a fluid. For example, in some embodiments, the filter media, systems, and devices described herein can be used for produced water treatment applications, oil/hydrocarbon contamination mitigation, point-of-use (POU) filters for households, membrane pretreatment, and emergency water supply filters.

Moringa oleifera (MO) seed protein extracts can be used in some embodiments for water treatment applications due to their coagulation, antibacterial, and anti-viral properties. The seeds can remove 7-log of MS2 virus and 8-log of E. coli. Furthermore, interactions with two cationic proteins obtained from MO, MO chitin-binding protein (MOCBP) and MO coagulant protein (MO2.1), can remove microbials and other nonmicrobial contaminates for use in low-resource settings for filtration of drinking water.

### DESCRIPTION OF DRAWINGS

FIG. 1 shows a natural fiber filter made from Moringa seed extract and Ceiba pentandra (kapok) fibers for oil and microbial removal. Cationic antimicrobial proteins can be extracted from Moringa seeds and can adsorb to oleophilic kapok fibers, creating an antibacterial-oleophilic filter. MO2.1 and MOCBP proteins contribute to antimicrobial activity. Kapok fibers provide a hydrophobic surface for oil interaction and adsorption that occurs simultaneously with microbial removal.

FIGS. 2A-2D show (A) MO proteins adsorbed to kapok fibers are shown to de-sorb in a 600 mM NaCl salt wash and confirmed through SDS-PAGE analysis (full size gel shown in FIG. 5). (B) SEM image of MO-coated kapok fibers following E. coli filtration experiment confirms adsorption of MO proteins to kapok fibers (no adsorption shown in FIG. 9B) and adherence of E. coli to MO-coated kapok fibers. (C) Increasing salinity is shown to decrease E. coli removal, but high removal persists (99.9%) at 155.7 mM ionic strength. Salinity values shown represent the ionic strength of the E. coli solution filtered through the columns. Note that increasing salinity experiments were conducted at a loading rate of 0.677 m/h (2 ml/min). (D) Increasing flowrate is shown to decrease E. coli removal but maintain >99% removal up to 4.75 m/h loading rate. Note that increasing flowrate experiments were conducted at 90.1 mM ionic strength. Error bars denote standard error from triplicate experiments.

FIGS. 3A-3B show (A) MO-coated kapok is shown to slightly increase oil removal from control kapok (K Control) in oil filtration. When bacteria are present, kapok filters achieve higher removal than when filtering oil only, most likely due to coalescence and flocculation. WS media (W Control) achieve similar, but slightly lower, oil removal to kapok when bacteria is not present. Removal of oil is significantly decreased when bacteria is present. * Indicates triplicates fell below GC-MS detection limit of 5 ng/μL, resulting in greater than 99.95% oil removal and a concentration of less than 4 mg/L in effluent samples. (B) E. coli removal is shown for filtration experiments using MO-coated kapok, control (uncoated) kapok (K Control), and WS media (W Control). MO-coated kapok shows increased bacterial removal in the presence of oil. This is likely due to flocculation/coalescence of bacteria and oil that allows for more bacteria to interact with MO proteins. Control kapok experiments show little difference in bacterial removal when oil is added to filtration. This shows the significance of MO proteins on kapok to further increase bacteria removal in the presence of oil. WS media shows very low bacteria removal. Error bars denote standard error from triplicate experiments. Note that results shown here were all conducted at a filtration loading rate of 3.39 m/h (10 ml/min) with 90.1 mM ionic strength.

FIG. 4 shows oil droplet size distribution for oil/water emulsion shows oil droplet sizes ranging from 0.1-10 μm.

FIG. 5 shows a full image from SDS-PAGE analysis showing the 600 mM NaCl wash from MO-coated kapok filters. Three samples are shown in three different dilutions with two protein standards on the ends of the gel.

FIG. 6 shows total ion chromatograms (TIC) for 100 and 75 ng/μL methyl oleate and methyl linoleate standards in hexane.

FIG. 7 shows total ion chromatograms (TIC) for samples from MO-coated kapok filtration of oil only.

FIG. 8 shows a standard curve of methyl oleate peak areas from samples 0-100 ng/μL.

FIGS. 9A-9B show (A) MO-coated kapok filters achieve 7-log removal of E. coli. Removal is significantly improved over control (uncoated) kapok filters, which achieve 0.1-0.4-log removal. (B) Kapok fibers appear to have a smooth texture when no MO proteins or E. coli is present.

FIG. 10 shows turbidity reduction of oil-in-water emulsion with control and MO serum addition for Example 1.

FIG. 11 shows oil removal and effluent concentrations for uncoated kapok and MO-coated kapok filters during oil filtration and simultaneous oil and E. coli filtration as analyzed in Example 1.

FIGS. 12A-12B show (A) MO-coated and control filter E. coli removal for simultaneous oil and E. coli removal experiments and (B) E. coli removal with and without the presence of oil as observed in Example 1.

FIG. 13 shows a process of protein purification and identification according to Example 2. Moringa oleifera seed extract is coated onto cotton balls and eluted with a high salinity wash. The solution is then dialyzed to decrease salt concentration. The purified protein solution was analyzed via SDS-PAGE and gel bands were excised and sent to the University of Texas Biological Mass Spectrometry Facility for protein identification.

FIG. 14 shows PFAS removal using three types of protein (MO protein, BSA, and lysozyme) and the control (DI water). PFAS removal is high when a pure water matrix is used. However, when diluted with methanol, PFAS removal decreases, indicating a PFAS-protein dissociation and subsequent PFAS detection via LC-MS/MS.

FIGS. 15A-15C show A) PFOA ¹⁹F NMR spectra at a constant concentration (50 mg/L) with protein concentrations 0 μg/L (red), 10 μg/L (green) and 40 μg/L (blue) B) PFOS 19F spectra at a constant concentration (50 mg/L) with protein concentrations 0 μg/L (red), 10 μg/L (green) and 40 μg/L (blue). The TFMAA signal is not shown. C) NMR peak height ratio, B, for constant PFAS concentration (50 mg/L) and varying MO protein concentration.

FIGS. 16A-16B show the highest affinity docking configurations for PFOA and PFOS with MO proteins MO2.1 (FIG. 16A) and MoCBP (FIG. 16B).

FIGS. 17A-17D show molecular dynamics simulations indicating several stable MO-PFAS configurations (FIG. 17A, MOCBP and PFOS; FIG. 17B, MOCBP and PFOA;

FIG. 17C, MO2.1 and PFOS; FIG. 17D, MO2.1 and PFOA) and ability for high-capacity binding.

FIG. 18 shows relative adsorption affinity of the MO protein and PFAS configurations obtained from the molecular dynamic simulations.

FIG. 19 shows a per-residue analysis of the MO protein and PFAS configurations for several amino acids.

FIG. 20 shows comparative removal of PFOS by MO-coated kapok fiber filtration.

FIG. 21 shows PFOS/PFOA separate filtration by a MO-coated cotton filter at an initial concentration of 30 μg/L.

FIG. 22 shows PFOS/PFOA simultaneous filtration by a MO-coated cotton filter at an initial concentration of 30 μg/L.

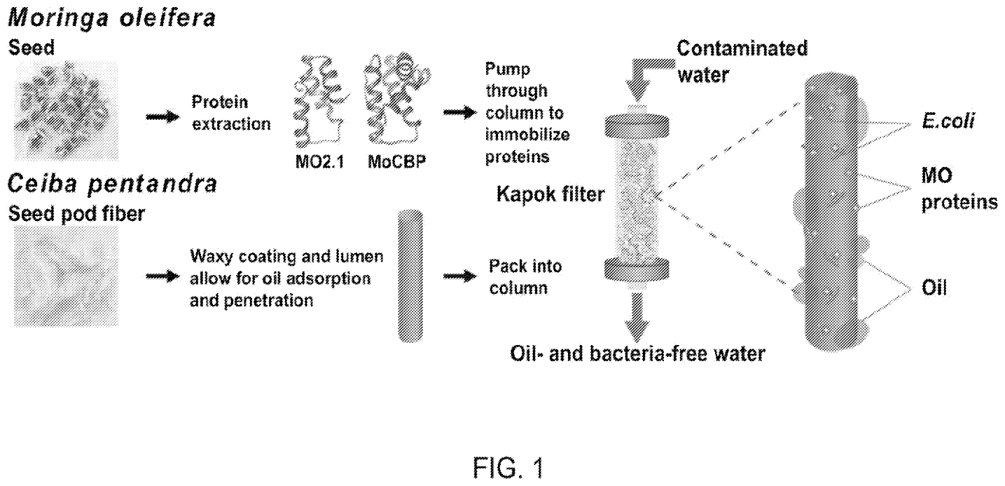

### DETAILED DESCRIPTION

### Definitions

As used herein, the term “hydrophobic” may refer to material that has a water contact angle of greater than or equal to 90 degrees (e.g., greater than or equal to 120 degrees, greater than or equal to 150 degrees). Accordingly, a “hydrophobic surface” or “hydrophobic fiber” may refer to a surface or fiber that has a water contact angle of greater than 90 degrees. In some embodiments, the surface or fiber may be modified to be hydrophobic such that the water contact angle is greater than 90 degrees, greater than or equal to 100 degrees, greater than or equal to 105 degrees, greater than or equal to 110 degrees, greater than or equal to 115 degrees, greater than or equal to 120 degrees, greater than or equal to 125 degrees, greater than or equal to 130 degrees, greater than or equal to 135 degrees, greater than or equal to 145 degrees, greater than or equal to 150 degrees, greater than or equal to 155 degrees, or greater than or equal to 160 degrees. In some instances, the water contact angle is less than or equal to about 160 degrees, less than or equal to about 150 degrees, less than or equal to about 135 degrees, less than or equal to about 120 degrees, or less than or equal to about 105 degrees. Combinations of the above-referenced ranges are also possible (e.g., greater than or equal to 90 degrees and less than about 160 degrees, greater than or equal to about 105 degrees and less than about 150 degrees, greater than or equal to 90 degrees and less than about 140 degrees, or greater than or equal to 90 degrees and less than about 130 degrees). The contact angle is the angle between the substrate surface or fiber and the tangent line drawn to the water droplet surface at the three-phase point, when a liquid drop is resting on a plane solid surface. A contact angle meter or goniometer can be used for this determination.

As used herein, the term “oleophilic” may refer to material that has a n-hexadecane contact angle of less than 90 degrees. Accordingly, an “oleophilic surface” or “oleophilic fiber” may refer to a surface or fiber that has a n-hexadecane contact angle of less than 90 degrees. In some embodiments, the surface or fiber may be modified to be oleophilic such that the n-hexadecane contact angle is less than 90 degrees, less than or equal to about 80 degrees, less than or equal to about 75 degrees, less than or equal to about 70 degrees, less than or equal to about 65 degrees, less than or equal to about 60 degrees, less than or equal to about 55 degrees, less than or equal to about 50 degrees, less than or equal to about 45 degrees, less than or equal to about 40 degrees, less than or equal to about 35 degrees, less than or equal to about 30 degrees, less than or equal to about 25 degrees, or less than or equal to about 20 degrees. In some embodiments, the n-hexadecane contact angle is greater than or equal to about 20 degrees, greater than or equal to about 25 degrees, greater than or equal to about 35 degrees, greater than or equal to about 45 degrees, or greater than or equal to about 60 degrees. Combinations of the above-referenced ranges are also possible (e.g., greater than or equal to about 20 degrees and less than 90 degrees, greater than or equal to about 20 degrees and less than about 60 degrees). The contact angle is the angle between the substrate surface or fiber and the tangent line drawn to the n-hexadecane droplet surface at the three-phase point, when a liquid drop is resting on a plane solid surface. A contact angle meter or goniometer can be used for this determination.

As used herein, the terms “MO”, “MO protein” and “MO coagulant protein” refer to small storage proteins predominantly found in the seeds of Moringa sp., particularly Moringa oleifera. “MO2.1” refers to one such MO protein, which is 60 amino acids in length identified from the seeds of Moringa oleifera and cloned by Broin et al. (2002). The terms also cover a composition containing the MO protein, which is obtainable using a method according to the present disclosure.

As used herein, the term “disposed” refers to the immobilization of a microbial binding material (e.g., a protein extracted from Moringa oleifera seeds) on a hydrophobic fiber (e.g., kapok fibers). The first material is retained through some affinity between the first material and the second material. For example, the microbial binding material can be electrostatically disposed (e.g., associated through electrostatic interactions), physisorbed, chemisorbed, adsorbed, and/or condensed on the hydrophobic fibers. In certain cases, the microbial material can be electrostatically disposed on the hydrophobic fibers.

As used herein, the term “delipidation” refers to the process of removing lipids or lipid groups, often from a protein, which is generally known in the art. Centrifugation is a process in which centripetal force is applied for the differential sedimentation of a heterogeneous mixture of different compounds, e.g., proteins. This process is widely used in industry and research for the purpose of purifying proteins and otherwise, and thus widely known in the art.

Chromatography is a process in which a mixture of different compounds, e.g., proteins, is separated based on the compounds' different rates of migration through a medium. Ion exchange chromatography is a specific type of chromatography where the different compounds are separated based on their respective charges. Use of chromatography in general and ion exchange chromatography in particular for the purpose of protein purification are widely known in the art.

As used herein, the term “fluid” refers to a substantially liquid solution, suspension, and/or emulsion. For example, the fluid can comprise a mixture of water, hydrocarbons, and solids. Hydrocarbons can comprise less than 80% of the total fluid weight. In some embodiments, an oil can comprise less than 75%, less than 70%, less than 65%, less than 60%, less than 55%, less than 50%, less than 45%, less than 40%, less than 35%, less than 30%, less than 25%, less than 20%, less than 15%, less than 10%, less than 5% of the total fluid weight. In some examples, the fluid can comprise solids. In some embodiments, the solids can comprise microbes. The microbes can be any bacteria, virus, fungi, or other microorganism, for example, Escherichia coli (E. coli), Salmonella, Shigella, Vibrio, Campylobacter, Cryptosporidium, Giardia, enteroviruses, adenoviruses, noroviruses, rotaviruses, and hepatitis A virus. For example, the solids can be present in an amount of less than 100,000 mg/L, less than 75,000 mg/L, less than 50,000 mg/L, less than 40,000 mg/L, less than 30,000 mg/L, less than 20,000 mg/L, less than 10,000 mg/L, less than 5,000 mg/L, less than 2,500 mg/L, less than 1,000 mg/L, less than 500 mg/L, less than 100 mg/L, less than 50 mg/L, or about 0 mg/L. In some embodiments, the fluid can be produced waters.

### Filter Media

Described herein is a filter media for use in removing contaminates from a fluid. In some embodiments, the filter media may comprise a hydrophobic fiber and a microbial binding material disposed (e.g., electrostatically disposed) thereon.

The microbial binding material can be disposed on the hydrophobic fibers in varying amounts. In some embodiments, the microbial binding material may be disposed on the hydrophobic fiber in an amount of at least 1 mg microbial binding material/g hydrophobic fiber (e.g., at least 2.5 mg microbial binding material/g hydrophobic fiber, at least 5 mg microbial binding material/g hydrophobic fiber, at least 10 mg microbial binding material/g hydrophobic fiber, at least 15 mg microbial binding material/g hydrophobic fiber, at least 20 mg microbial binding material/g hydrophobic fiber, at least 25 mg microbial binding material/g hydrophobic fiber, at least 30 mg microbial binding material/g hydrophobic fiber, at least 35 mg microbial binding material/g hydrophobic fiber, at least 40 mg microbial binding material/g hydrophobic fiber, at least 45 mg microbial binding material/g hydrophobic fiber, at least 50 mg microbial binding material/g hydrophobic fiber, at least 55 mg microbial binding material/g hydrophobic fiber, at least 60 mg microbial binding material/g hydrophobic fiber, at least 65 mg microbial binding material/g hydrophobic fiber, at least 70 mg microbial binding material/g hydrophobic fiber, at least 75 mg microbial binding material/g hydrophobic fiber, at least 80 mg microbial binding material/g hydrophobic fiber, at least 85 mg microbial binding material/g hydrophobic fiber, at least 90 mg microbial binding material/g hydrophobic fiber, or at least 95 mg microbial binding material/g hydrophobic fiber). In some embodiments, the microbial binding material may be disposed on the hydrophobic fiber in an amount of 100 mg microbial binding material/g hydrophobic fiber or less (e.g., 95 mg microbial binding material/g hydrophobic fiber or less, 90 mg microbial binding material/g hydrophobic fiber or less, 85 mg microbial binding material/g hydrophobic fiber or less, 80 mg microbial binding material/g hydrophobic fiber or less, 75 mg microbial binding material/g hydrophobic fiber or less, 70 mg microbial binding material/g hydrophobic fiber or less, 65 mg microbial binding material/g hydrophobic fiber or less, 60 mg microbial binding material/g hydrophobic fiber or less, 55 mg microbial binding material/g hydrophobic fiber or less, 50 mg microbial binding material/g hydrophobic fiber or less, 45 mg microbial binding material/g hydrophobic fiber or less, 40 mg microbial binding material/g hydrophobic fiber or less, 35 mg microbial binding material/g hydrophobic fiber or less, 30 mg microbial binding material/g hydrophobic fiber or less, 25 mg microbial binding material/g hydrophobic fiber or less, 20 mg microbial binding material/g hydrophobic fiber or less, 15 mg microbial binding material/g hydrophobic fiber or less, 10 mg microbial binding material/g hydrophobic fiber or less, 5 mg microbial binding material/g hydrophobic fiber or less, or 2.5 mg microbial binding material/g hydrophobic fiber or less).

The microbial binding material can be disposed on the hydrophobic fiber in an amount ranging from any of the minimum values described above to any of the maximum values described above. For example, in some embodiments, the microbial binding material may be disposed on the hydrophobic fiber in an amount of from 1 to 100 mg microbial binding material/g hydrophobic fiber, such as from 1 to 10 mg microbial binding material/g hydrophobic fiber, from 1 to 5 mg microbial binding material/g hydrophobic fiber, or from 2.5 to 5 mg microbial binding material/g hydrophobic fiber.

In some embodiments, the filter media may be present as loose fibers. In some embodiments, these loose fibers can be packed (e.g., in a housing, casing, or filter bed) to form a filter. According to some embodiments, the filter media described herein may be a non-woven web. A non-woven web may, for example, include non-oriented fibers (e.g., a random arrangement of fibers within the web). Examples of non-woven webs include webs made by wet-laid or non-wet laid processes.

The filter media can also be incorporated into a variety of filter elements for use in various filtering applications. Exemplary types of filters include hydraulic mobile filters, hydraulic industrial filters, fuel filters (e.g., automotive fuel filters), oil filters (e.g., lube oil filters or heavy duty lube oil filters), chemical processing filters, industrial processing filters, medical filters (e.g., filters for blood), air filters, and water filters. In some cases, filter media described herein can be used as coalescer filter media. The filter media may be suitable for filtering gases or liquids.

During or after formation of a filter media, the filter media may be further processed according to a variety of known techniques. For instance, a coating method described herein may be used to include a resin in the filter media. Additionally or alternatively, a coating or other method may be used to modify a surface. In some embodiments, the filter media may be formed in one or more layers for membrane filtration. Optionally, additional layers can be formed and/or added to a filtration media using processes such as lamination, co-pleating, or collation. For example, in some cases, two layers are formed into a composite article by a wet laid process as described above, and the composite article is then combined with a third layer by any suitable process (e.g., lamination, co-pleating, or collation). It can be appreciated that a filter media or a composite article formed by the processes described herein may be suitably tailored not only based on the components of each fiber layer, but also according to the effect of using multiple fiber layers of varying properties in appropriate combination to form fiber webs having the characteristics described herein.

The filter media can have any suitable overall density, such as about 10 to about 400 g/m2, or about 80 to about 250 g/m2, or about 10 g/m2 or less, or less than, equal to, or greater than about 20 g/m2, 40, 60, 80, 100, 125, 150, 175, 200, 225, 250, 275, 300, 325, 350, 375, or about 400 g/m2 or more. The filter media may have any suitable thickness, from several millimeters to several centimeters, as the desired application may require. In certain embodiments, a filter comprising a filter media can be provided. The filter can include a single layer of the filter media or multiple layers. The multiple layers can independently be adjacent or separate within the filter. For example, the filter can include 1, 2, 3, 4, 5, 6, 7, 8, 9, or 10 or more layers of the filter media.

Also described herein filter medias for decreasing the concentration of a per- and polyfluoroalkyl substance (PFAS). In various embodiments, the filter media comprises a fibrous substrate and a cationic binder disposed thereon.

As used herein, the term “fibrous substrate” refers to materials comprised of synthetic fibers e.g., wovens, knits, nonwovens, carpets, and other textiles; materials comprised of natural fibers, such as kapok fibers, silk fibers, milkweed fibers, polyolefin fibers, cotton, polyester fibers, as well as combinations thereof. In some embodiments, the fibrous substrate includes one or more hydrophobic fibers. In some embodiments, the fibrous substrate is oleophilic. The fibrous substrate can, for example, include a fibrous substrate that has been functionalized to increase oleophilicity, such as by those methods described in U.S. Pat. No. 10,240,031 which is hereby incorporated by reference.

The cationic binder, which includes any can comprise one or more cationic proteins which may attract a negatively charged microbe or other nonmicrobial contaminate. For example, the cationic material can comprise a Moringa oleifera seed extract, such as a cationic protein derived from the seeds of Moringa oleifera.

In some embodiments, the filter media may be present as loose fibers. In some embodiments, these loose fibers can be packed (e.g., in a housing, casing, or filter bed) to form a filter. In various embodiments, the filter media can be packed into a housing including a porous or semi-porous membrane, such as a fabric. A porous or semi-porous membrane can allow a contaminated fluid to permeate the housing and thereby contact the filter media (e.g., as packed loose fibers). The porous or semi-porous membrane can comprise a hydrophobic and/or oleophilic material and/or can be a material that has been functionalized to exhibit an increased level of hydrophobicity and/or oleophilicity. Some suitable membrane materials include those described in WO 2022/060406.

According to some embodiments, the filter media described herein may be a non-woven web. A non-woven web may, for example, include non-oriented fibers (e.g., a random arrangement of fibers within the web). Examples of non-woven webs include webs made by wet-laid or non-wet laid processes.

The filter media can also be incorporated into a variety of filter elements for use in various filtering applications. Exemplary types of filters include hydraulic mobile filters, hydraulic industrial filters, fuel filters (e.g., automotive fuel filters), oil filters (e.g., lube oil filters or heavy duty lube oil filters), chemical processing filters, industrial processing filters, medical filters (e.g., filters for blood), air filters, and water filters. In some cases, filter media described herein can be used as coalescer filter media. The filter media may be suitable for filtering gases or liquids.

During or after formation of a filter media, the filter media may be further processed according to a variety of known techniques. For instance, a coating method described herein may be used to include a resin in the filter media. Additionally or alternatively, a coating or other method may be used to modify a surface. In some embodiments, the filter media may be formed in one or more layers for membrane filtration. Optionally, additional layers can be formed and/or added to a filtration media using processes such as lamination, co-pleating, or collation. For example, in some cases, two layers are formed into a composite article by a wet laid process as described above, and the composite article is then combined with a third layer by any suitable process (e.g., lamination, co-pleating, or collation). It can be appreciated that a filter media or a composite article formed by the processes described herein may be suitably tailored not only based on the components of each fiber layer, but also according to the effect of using multiple fiber layers of varying properties in appropriate combination to form fiber webs having the characteristics described herein.

The filter media can have any suitable overall density, such as about 10 to about 400 g/m2, or about 80 to about 250 g/m2, or about 10 g/m2 or less, or less than, equal to, or greater than about 20 g/m2, 40, 60, 80, 100, 125, 150, 175, 200, 225, 250, 275, 300, 325, 350, 375, or about 400 g/m2 or more. The filter media may have any suitable thickness, from several millimeters to several centimeters, as the desired application may require. In certain embodiments, a filter comprising a filter media can be provided. The filter can include a single layer of the filter media or multiple layers. The multiple layers can independently be adjacent or separate within the filter. For example, the filter can include 1, 2, 3, 4, 5, 6, 7, 8, 9, or 10 or more layers of the filter media.

### Hydrophobic Fibers

The hydrophobic fiber can comprise any suitable hydrophobic fiber known in the art. The hydrophobic fiber may comprise a fiber that has a water contact angle of greater than 90 degrees. In some embodiments, the hydrophobic fiber may be hydrophobic such that the water contact angle is greater than 90 degrees, greater than or equal to 100 degrees, greater than or equal to 105 degrees, greater than or equal to 110 degrees, greater than or equal to 115 degrees, greater than or equal to 120 degrees, greater than or equal to 125 degrees, greater than or equal to 130 degrees, greater than or equal to 135 degrees, greater than or equal to 145 degrees, greater than or equal to 150 degrees, greater than or equal to 155 degrees, or greater than or equal to 160 degrees. In some instances, the water contact angle is less than or equal to about to about 160 degrees, less than or equal to about 135 degrees, less than or equal to about 120 degrees, or less than or equal to about 105 degrees. Combinations of the above-referenced ranges are also possible (e.g., greater than or equal to 90 degrees and less than about 160 degrees, or greater than or equal to about 105 degrees and less than about 160 degrees). The contact angle is the angle between the substrate surface or fiber and the tangent line drawn to the water droplet surface at the three-phase point, when a liquid drop is resting on a plane solid surface. A contact angle meter or goniometer can be used for this determination.

Suitable hydrophobic fibers are known in the art. Examples of hydrophobic fibers include kapok fibers, silk fibers, milkweed fibers, polyolefin fibers, polyester fibers, combinations of these fibers, and combinations of these and/or other materials. Different hydrophobic and/or oleophilic materials may also be prepared together for use in the filter media. In another illustrative embodiment, the hydrophobic fibers may be composed of a single material, such as kapok.

In some embodiments, the hydrophobic fiber can have an average fiber length from 5 to 100 mm, such as from 5 to 75 mm, from 5 to 50 mm, from 10 to 50 mm, or from 10 to 30 mm. Additionally, the hydrophobic fibers may have an average fiber diameter from 5 to 100 mm, such as from 5 to 75 mm, from 5 to 50 mm, from 10 to 40 mm, or from 10 to 25 mm.

In some embodiments, the hydrophobic fiber may comprise an oleophilic fiber. In these embodiments, the oleophilic fiber may have a n-hexadecane contact angle of less than 90 degrees. In some embodiments, the fiber may be provided to be oleophilic such that the n-hexadecane contact angle is less than 90 degrees, less than or equal to about 80 degrees, less than or equal to about 75 degrees, less than or equal to about 70 degrees, less than or equal to about 65 degrees, less than or equal to about 60 degrees, less than or equal to about 55 degrees, less than or equal to about 50 degrees, less than or equal to about 45 degrees, less than or equal to about 40 degrees, less than or equal to about 35 degrees, less than or equal to about 30 degrees, less than or equal to about 25 degrees, or less than or equal to about 20 degrees. In some embodiments, the n-hexadecane contact angle is greater than or equal to about 20 degrees, greater than or equal to about 25 degrees, greater than or equal to about 35 degrees, greater than or equal to about 45 degrees, or greater than or equal to about 60 degrees. Combinations of the above-referenced ranges are also possible (e.g., greater than or equal to about 20 degrees and less than 90 degrees, greater than or equal to about 20 degrees and less than about 60 degrees). The contact angle is the angle between the substrate surface or fiber and the tangent line drawn to the n-hexadecane droplet surface at the three-phase point, when a liquid drop is resting on a plane solid surface. A contact angle meter or goniometer can be used for this determination. In certain embodiments, the hydrophobic fibers can absorb oil. The oil absorption capacity of a fibrous material can be quantified using the standard test methods described in ASTM F726-06, entitled “Standard Test Method for Sorbent Performance of Adsorbents,” which is incorporated herein by reference in its entirety. In some embodiments, the hydrophobic fiber may have an absorption capacity as measured by standard ASTM F726-06 from 1 g oil/g fiber to 100 g oil/g fiber, such as from 1 g oil/g fiber to 80 g oil/g fiber, 10 g oil/g fiber to 80 g oil/g fiber, 10 g oil/g fiber to 60 g oil/g fiber, 30 g oil/g fiber to 60 g oil/g fiber, or 40 g oil/g fiber to 50 g oil/g fiber. In some embodiments, the hydrophobic fiber can comprise kapok fibers. Kapok fibers are obtained from fruits of Ceiba pentandra (L.) Gaertn. trees which belong to the family of the Malvaceae plants. In some embodiments, natural kapok fibers are used with fiber lengths of 25±5 mm in length, outside diameter of 16.5±2.4 mm and with an average wall thickness of 2.0 μm. Tube walls are composed of cellulose, hemicelluloses and lignin. Bulk density of kapok fibers in some embodiments is 0.0013 g/cm3 with 77 vol. % of the fibers as empty lumen. Hydrophobicity may be enhanced due to acetylation of the wall saccharides and due to the coating of the tube wall surface with natural waxes. This lumen may be filled with hydrophilic/oleophilic substance when fibers come to contact with it. Absorption capacity of the kapok fiber, measured according to standard ASTM F726-06, may, for example, be at a package density of 0.02 g/cm3, which is 41 g/g to 45 g/g for engine oil HD 40 and 31 g/g to 36 g/g for diesel fuel D2 (Hori et al 2000, Mungasatkit 2004, Lim and Huang 2007). Kapok fibers can be characterized as a natural super absorbent for water and hard surface cleaning.

### Microbial Binding Material

In some embodiments, the microbial binding material may be, for example, a material with an affinity to microbes. In some embodiments, the microbial binding material can comprise one or more cationic proteins which can attract negatively charged microbes or other contaminates. For example, the microbial binding material may comprise a Moringa oleifera seed extract, such as a cationic protein derived from the seeds of Moringa oleifera.

In some embodiments, the seeds of Moringa oleifera may be substantially purified to provide one or more cationic proteins. For example, the purification of Moringa oleifera may results in an extract comprising Moringa oleifera chitin-binding protein (MOCBP) and/or Moringa oleifera coagulant protein (MO2.1), or other proteins, including for example various cationic proteins. These extracted proteins may be obtained, for example, by one or a combination of dialysis, delipidation, centrifugation and ion exchange chromatography, or any other process known in the art.

MO2.1 not functionalized on the surface of any filter media has been reported as being effective in the removal of certain algae (e.g., Chlorella, Microcystis, Oocystis and Scenedesmus) by flocculation. Barrado-Moreno et al., Toxicon 110:68-73 (2015). MO2.1 has also been reported to cause destabilization and sedimentation of colloidal particles. Kansal & Kumari, Chemical Reviews 114:4993-5010 (2014). The mechanism by which MO2.1 induces coagulation has been described as adsorption and neutralization of charges and inter-particle bridging. The zeta potential of a typical MO2.1 solution is reportedly positive, and the zeta potential of synthetic water is negative; hence, the MO2.1 destabilizes negatively charged colloids. Kansal & Kumari, Chemical Reviews 114:4993-5010 (2014); Jerri et al., Langmuir 28:2262-2268 (2011).

MO2.1 treats water by acting both as a coagulant and as an antimicrobial agent. MO2.1 damages the cell wall of bacteria via membrane fusion and kills the bacteria. MO2.1 induces bacterial cell death by interfering with the bacterial cell membrane. The initial interaction between MO2.1 and the bacterial cell membrane is facilitated by the protein's net positive charge. And MO2.1's amphiphilic helix-loop-helix motif then facilitates the proteins incorporation into bacterial membranes.

MO2.1 can target and kill many microbes, most notably microbes found in contaminated water that are considered harmful to human health. MO2.1 has been noted to bind more favorably to anionic lipids, and through the process of membrane fusion, it is able to deactivate negatively charged microbes. MO2.1 has been reported to remove numerous heterophobic microbials including, for example, streptococci, clostridium, E. coli, and Helminth eggs. The mechanism of MOCBP viral interaction with MS2, a surrogate for human enteric viruses, has been shown to occur through a chitin-binding region on the protein that favorably interacts with MS2 capsid proteins.

Although the microbial binding material is described above for its affinity to microbes, the binding material can also be similarly effective at removing other types of nonmicrobial contaminates. As used herein, references to, for example, a filter media comprising a microbial binding material is not intended to limit uses of said filter media solely to those systems and applications primarily involving the removal of a microbial contaminate. Thus, a material may still be considered a microbial binding material even where its ultimate end-use relates to systems and applications for the removal of nonmicrobial contaminates.

### Filters, Systems, and Methods

Also described are filters comprising the filter media described herein. In some embodiments, the filter media may be disposed within a housing. The housing can secure and/or contain the filter media to facilitate passage of a fluid through the filter media. In certain embodiments, the filter media may be packed within the housing at a density of from 0.05 to 1 g/cm³, such as from 0.05 to 0.5 g/cm³, or from 0.05 to 0.15 g/cm³.

The filters described herein can be use in various filtering applications. Exemplary types of filters include hydraulic mobile filters, hydraulic industrial filters, fuel filters (e.g., automotive fuel filters), oil filters (e.g., lube oil filters or heavy duty lube oil filters), chemical processing filters, industrial processing filters, medical filters (e.g., filters for blood), air filters, and water filters. In some cases, filter media described herein can be used as coalescer filter media. The filter media may additionally be suitable for filtering gases or liquids.

Described herein are systems for decreasing the concentration of a contaminant in a fluid. In some embodiments, the system comprises a fluid source and a filtration unit comprising a fluid inlet fluidly connected to the fluid source, a housing comprising a filter media therewithin, and a fluid outlet. The housing can secure and/or contain the filter media to facilitate passage of a fluid through the filter media. In certain embodiments, the filter media may be packed within the housing at a density of from 0.05 to 1 g/cm³, such as from 0.05 to 0.5 g/cm³, or from 0.05 to 0.15 g/cm³.

According to other embodiments, the filtration unit may comprise a packed filter bed. To ensure adequate removal of the contaminates, it is important to provide an appropriate flow rate through the packed filter bed. In certain embodiments, the fluid flows from the fluid source and through the packed filter bed at a flowrate of from 0.5 and 10 m/h, such as from 0.5 and 5 m/h, 1 to 5 m/h, or from 2.5 and 5 m/h. In addition, the system can be configured to operate continuously or semi-continuously.

The system may be used to remove contaminates from various fluids, including for example produced waters. The level of contamination for produced water varies with geography and shale basins. For example, the Bakken, Marcellus, and Utica contain some of the most contaminated produced waters. These produced waters typically contain high total dissolved solids (TDS) in excess of or less than 150,000 mg/L. Other produced waters contain different TDS, for example less than 100,000 mg/L, less than 75,000 mg/L, less than 50,000 mg/L, less than 40,000 mg/L, less than 30,000 mg/L, less than 20,000 mg/L, less than 10,000 mg/L, less than 5,000 mg/L, less than 2,500 mg/L, less than 1,000 mg/L, less than 500 mg/L, less than 100 mg/L, less than 50 mg/L, or about 0 mg/L.

In additional embodiments, the fluid may comprise an aqueous solution. As used herein, an aqueous solution may further comprise hydrophobic materials, such as oils, grease, hydrocarbons. In embodiments where the fluid comprises a hydrocarbon, passing the fluid through the filter media may reduce the concentration of the hydrocarbon by at least 30%, such as at least 40%, at least 50%, at least 60%, at least 70%, at least 80%, at least 90%, at least 95%, at least 99%.

In various embodiments, the filter reduces the concentration of a contaminate by at least 30%, such as at least 40%, at least 50%, at least 60%, at least 70%, at least 80%, at least 90%, at least 95%, at least 99%. When the contaminate comprises a bacteria, microorganism (e.g., giardia), and/or virus, the filter may reduce the concentration of the bacteria, microorganism, and/or virus by at least 30%, such as at least 40%, at least 50%, at least 60%, at least 70%, at least 80%, at least 90%, at least 95%, at least 99%. In other embodiments where the contaminate comprises a bacteria, microorganism, and/or virus, passing the fluid through the filter may reduce the bacteria, microorganism, and/or virus by 3-log or greater, such as 4-log or greater, 5-log or greater, or 6-log or greater (e.g. from 3-log to 7-log, from 4-log to 7-log, from 5-log to 7-log, or from 6-log to 7-log).

In some embodiments, the contaminate comprises a bacteria and a hydrocarbon. According to these embodiments, the filter media may reduce the bacteria by 3-log or greater, such as 4-log or greater, 5-log or greater, or 6-log or greater, and reduce the concentration of hydrocarbon can be reduced by at least 30%, such as at least 40%, at least 50%, at least 60%, at least 70%, at least 80%, at least 90%, at least 95%, at least 99%, at least 99.5%, at least 99.95%.

In various embodiments, the contaminate comprises an organofluorine compound such as a per-fluoroalkyl and poly-fluoroalkyl substance (“PFAS”). PFAS are a diverse group of fluorosurfactants having a variety of properties that make them useful in a wide range of industrial applications, such as water and stain repellents, aviation hydraulic fluid, metal coatings and fire-fighting foams. Typically, PFAS have a molecular structure including a hydrophobic carbon chain (e.g., 2-16 carbons in length), in which all (per-) or part (poly-) of the hydrogens are substituted by fluorine atoms. PFAS can also include a hydrophilic polar functional groups (e.g., carboxylates, sulfonates, sulphonamides, phosphonates and alcohols). PFAS may be classified as (1) long-chain perfluoroalkyl acids, (2) short-chain perfluoroalkyl acids, (3) non-polymeric and polymeric fluorotelomer-based products, and (4) fluoroplastics and fluoropolymers. Long-chain PFAAs include perfluoroalkane sulfonic acids (PFSAs) with carbon chain lengths of 6 and higher, and perfluorocarboxylic acids (PFCAs) with carbon chain lengths of 8 and higher; and short-chain PFAAs, include PFSAs with carbon chain lengths of 5 and lower, and PFCAs with carbon chain lengths of 7 and lower.

Some examples of PFAS include perfluorobutanoic acid, perfluoropentanoic acid, perfluorohexanoic acid, perfluoroheptanoic acid, perfluorooctanoic acid, perfluorononanoic acid, perfluorodecanoic acid, perfluorobutanesulphonic acid, perfluorohexanesulphonic acid, perfluorooctanesulphonic acid, 6:2 fluorotelomer sulfonate, perfluoroundecanoic acid, perfluorododecanoic acid, perfluorotridecanoic acid, perfluorotetradecanoic acid, perfluoropentanesulphonic acid, perfluoroheptanesulphonic acid, perfluorononanesulphonic acid, perfluorodecanesulphonic acid, perfluorododecanesulphonic acid, 4:2 fluorotelomer sulfonate, 8:2 fluorotelomer sulfonate, perfluorooctanesulphone amide, N-methyl perfluorooctanesulphone amide, N-ethyl perfluorooctanesulphone amide, N-methyl perfluorooctanesulphone amide ethanol, N-ethylperfluorooctanesulphone amide ethanol, perfluorooctanesulphone amide acetate, N-methyl perfluorooctanesulphone amide acetate, N-ethyl perfluorooctanesulphone amide acetate, 7H-perfluoroheptanoic acid, perfluoro-3,7-dimethyloctanoic acid and isomers, homologs and other permutations of these substances.

In some embodiments, the present filters, systems, and methods are used to decrease the concentration of a PFAS in an aqueous solution. Advantageously, the filter media can decrease the concentration of one or more PFAS (e.g., perfluorooctanoic acid (PFOA) and/or perfluorooctane sulfonate (PFOS)) by at least 30%, such as at least 40%, at least 50%, at least 60%, at least 70%, at least 80%, at least 90%, at least 95%, at least 99%.

### Examples

The invention will be described in greater detail by way of specific examples. The following examples are offered for illustrative purposes, and are not intended to limit the invention in any manner. Those of skill in the art will readily recognize a variety of non-critical parameters which can be changed or modified to yield essentially the same results.

### Example 1: Removal of Oil and E. Coli in a Ceiba Pentandra Fiber Filter with Adsorbed Moringa Oleifera Proteins

### Materials and Methods

Moringa serum and functionalized kapok preparation. Whole unshelled Moringa oleifera seeds from Echo Global Farm in Florida were ground with a coffee grinder and mixed with modified ten times diluted phosphate-buffered saline (PBS) buffer with total dissolved solids (TDS) of 4,574 mg/L (75 mM NaCl, 0.27 mM KCl, 1 mM Na₂HPO₄, 0.18 mM KH₂PO₄), herein referred to as modified PBS. Modified PBS was used instead of deionized (DI) water to demonstrate the ability to use a more realistic water for protein extraction. For example, typical groundwater salinity ranges from 100 to >50,000 mg/L [32]. Crushed seeds (2 g per 100 mL) and modified PBS were mixed for 5 minutes followed by filtration through a 1.5 μm glass microfiber filter (VWR Inc). An in-situ coating process was employed for coating kapok. In this process, the seed extract (100 mL) was coated onto 2 g of kapok fibers packed into a disposable column at 2 mL/min using a peristaltic pump (Masterflex L/S Variable-Speed Digital Drive, Cole-Parmer).

Walnut shell media. Walnut shell (WS) media (20-30 mesh) was purchased to provide a baseline for oil removal due to its use in the produced water industry [33, 34]. WS preparation was adapted from similar work [35, 36]. Media was washed in DI water until the water ran clear. It was dried at 105° C. overnight and stored in an air-tight flask.

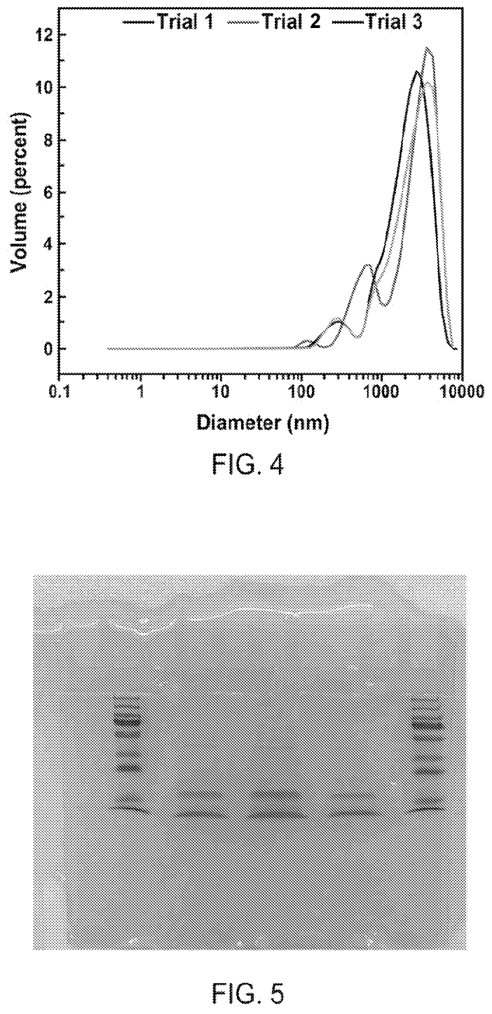

Model oily saline water. Canola oil was used as experimental oil in this study due to the use of vegetable oils in previous oil fouling related research [37, 38]. The oil/water emulsion was prepared by mixing 1% (w/w) canola oil in modified PBS using a blender. Constant mixing using a magnetic stir bar was used to keep the oil water emulsion stable for the duration of experiments. Particle size distribution of oily water using dynamic light scattering (DLS) is included in FIG. 4. Experiments for the removal of oil with and without bacteria were conducted at 10 mL/min flowrate (3.39 m/h loading rate).

For simultaneous E. coli and oil experiments, the oil/water emulsion was prepared by mixing 1.167% (w/w) canola oil in modified PBS using a blender. E. coli strain TG1 containing red fluorescent protein (pCA24N-rfp-lasR, [39]) were used as model bacteria at an approximate influent concentration of 10⁸ colony forming units (CFU)/mL suspended in PBS buffer (137 mM NaCl, 2.7 mM KCl, 10 mM Na₂HPO₄, 1.8 mM KH₂PO₄). Culture medium chemicals were removed from the cell suspension by rinsing pellets twice with PBS buffer. Culturing details were described in a previous study [40]. E. coli was added to the oil/water emulsion to dilute oil to a final concentration of 1% (w/w) and final salinity of 90.1 mM ionic strength concentration (82.8 mM NaCl, 0.617 mM KCl, 2.28 mM Na₂HPO₄, 0.411 mM KH₂PO₄). A conventional plate counting method was used to quantify cell concentrations [41].

Column experiments. The filter columns used were 10 cm disposable columns with an internal diameter of 1.5 cm. Column adapters (Bio-Rad) were used to eliminate head space in the columns. For kapok filtration media, raw kapok fibers were packed into the column evenly at a packing density of 0.11 g/cm³ (mass of fibers/column volume). For WS media, an equivalent volume was used (˜17.7 cm³). Peristaltic pumps were used to pump solution through columns with feed entering from the top of the column at a constant flowrate. Packed media was rinsed with 100 mL DI water to set flowrate. For MO-coated kapok experiments, 100 mL of Moringa serum was pumped through columns to functionalize kapok. Columns were equilibrated with background ionic strength solutions (100 mL) before switching to appropriate influent solutions. Sterilized vials were used to collect effluent samples (1 mL) at designated bed volumes of 2.78, 4.17, and 5.56 (50 mL, 75 mL, 100 mL).

Gel electrophoresis. To characterize the protein adsorbed on kapok, sodium dodecyl sulfate polyacrylamide gel electrophoresis (SDS-PAGE) evaluation was conducted. 15 mL of 600 mM NaCl solution was run through functionalized kapok column to de-sorb proteins, and the protein concentration in the eluent was measured by a fluorometric peptide assay (Pierce). Previous work shows that 600 mM NaCl is effective in desorbing proteins adsorbed on silica surfaces [42]. 12 μL of the eluent was loaded onto a 12% hand-cast SDS-PAGE gel. Coomassie staining was used to visualize the protein bands. A full-size gel is shown in FIG. 5. To identify the proteins, bands from the gel were incised, digested, and analyzed at the Proteomics Facility at UT Austin (Table 1).

TABLE 1
Results from the UT Auston Proteomic Facility showing MO2.1 and MOCBP as peptide sequence matches (PSMs).

| | | | | | | | | | | # |
|---|---|---|---|---|---|---|---|---|---|---|
| | | | | | | | | | | Peptides |
| | | | | | | | | | | (by |
| | | | | | | | | | | Search |
| | | | | | | | | | Score Sequest | Engine): |
| | | Coverage | # | # | # Unique | | MW | calc. | HT: Sequest | Sequest |
| Accession | Description | [%) | Peptides | PSMs | Peptides | #AAs | [kDa) | pl | HT | HT |
| 5DOM_1 | Chain A \| 2S albumin \| Moringa | 53 | 8 | 372 | 7 | 122 | 14.3 | 8.54 | 1395.67 | 8 |
| | oleifera (3735) | | | | | | | | | |
| 6VJ0_1 | Chain A \| Chitin-binding | 23 | 2 | 222 | 1 | 124 | 14.3 | 7.9 | 988.69 | 2 |
| | protein Mo-CBP4 \| Moringa | | | | | | | | | |
| | oleifera (3735) | | | | | | | | | |
| P35527 | SWISS-PROT: P35527 | 57 | 26 | 64 | 25 | 623 | 62.1 | 5.3 | 242.55 | 26 |
| | Tax_Id = 9606 | | | | | | | | | |
| | Gene_Symbol = KRT9 Keratin, | | | | | | | | | |
| | type I cytoskeletal 9 | | | | | | | | | |
| P04264 | SWISS-PROT: P04264 | 58 | 32 | 71 | 22 | 644 | 66 | 8.12 | 236.19 | 32 |
| | Tax_Id = 9606 | | | | | | | | | |
| | Gene_Symbol = KRT1 Keratin, | | | | | | | | | |
| | type II cytoskeletal 1 | | | | | | | | | |
| P13645 | SWISS-PROT: P13645 | 48 | 27 | 72 | 24 | 593 | 59.5 | 5.21 | 228.01 | 27 |
| | Tax_Id = 9606 | | | | | | | | | |
| | Gene_Symbol = KRT10 Keratin, | | | | | | | | | |
| | type I cytoskeletal 10 | | | | | | | | | |
| P35908 | SWISS-PROT: P35908 | 59 | 31 | 61 | 23 | 645 | 65.8 | 8 | 205.45 | 31 |
| | Tax_Id = 9606 | | | | | | | | | |
| | Gene_Symbol = KRT2 Keratin, | | | | | | | | | |
| | type II cytoskeletal 2 | | | | | | | | | |
| | epidermal | | | | | | | | | |
| P13647 | SWISS-PROT: P13647 | 16 | 10 | 16 | 5 | 590 | 62.3 | 7.74 | 44.19 | 10 |
| | Tax_Id = 9606 | | | | | | | | | |
| | Gene_Symbol = KRT5 Keratin, | | | | | | | | | |
| | type II cytoskeletal 5 | | | | | | | | | |
| ENSEMBL: | (Bos taurus) 63 kDa protein | 13 | 8 | 15 | 1 | 606 | 63.1 | 8.46 | 43.6 | 8 |
| ENSBTAP | | | | | | | | | | |
| 00000038253 | | | | | | | | | | |
| Q922U2 | SWISS-PROT: Q922U2 | 13 | 8 | 14 | 1 | 580 | 61.7 | 7.75 | 36.53 | 8 |
| | Tax_Id = 10090 | | | | | | | | | |
| | Gene_Symbol = Krt5 Keratin, | | | | | | | | | |
| | type | | | | | | | | | |
| | II cytoskeletal 5 | | | | | | | | | |
| P02533 | SWISS-PROT: P02533 | 13 | 5 | 12 | 2 | 472 | 51.6 | 5.16 | 31.22 | 5 |
| | Tax_Id = 9606 | | | | | | | | | |
| | Gene_Symbol = KRT14 Keratin, | | | | | | | | | |
| | type I cytoskeletal 14 | | | | | | | | | |
| Q86YZ3 | SWISS-PROT: Q86YZ3 | 7 | 5 | 8 | 5 | 2850 | 282.2 | 10 | 26.64 | 5 |
| | Tax_Id = 9606 | | | | | | | | | |
| | Gene_Symbol = HRNR Hornerin | | | | | | | | | |
| Q8VED5 | TREMBL: Q8VED5 | 8 | 5 | 9 | 1 | 531 | 57.5 | 7.69 | 23.63 | 5 |
| | Tax_Id = 10090 | | | | | | | | | |
| | Gene_Symbol = Krt79 Keratin | | | | | | | | | |
| | 79 | | | | | | | | | |
| P02769 | SWISS-PROT: P02769 (Bos | 6 | 3 | 6 | 3 | 607 | 69.2 | 6.18 | 22.07 | 3 |
| | taurus) Bovine serum albumin | | | | | | | | | |
| | precursor | | | | | | | | | |
| P50446 | SWISS-PROT: P50446 | 8 | 5 | 7 | 1 | 553 | 59.3 | 7.94 | 17.45 | 5 |
| | Tax_Id = 10090 | | | | | | | | | |
| | Gene_Symbol = Krt6a Keratin, | | | | | | | | | |
| | type II cytoskeletal 6A | | | | | | | | | |
| Q7RTS7 | SWISS-PROT: Q7RTS7 | 10 | 5 | 7 | 2 | 529 | 57.8 | 7.71 | 17.04 | 5 |
| | Tax_Id = 9606 | | | | | | | | | |
| | Gene_Symbol = KRT74 Keratin, | | | | | | | | | |
| | type II cytoskeletal 74 | | | | | | | | | |
| P00761 | Trypsin - Sus scrofa (Pig). | 16 | 3 | 6 | 3 | 231 | 24.4 | 7.18 | 15.69 | 3 |
| SWISS- | | | | | | | | | | |
| PROT: P00761 | | | | | | | | | | |
| Q5D862 | SWISS-PROT: Q5D862 | 3 | 2 | 3 | 2 | 2391 | 247.9 | 8.31 | 11.98 | 2 |
| | Tax_Id = 9606 | | | | | | | | | |
| | Gene_Symbol = FLG2 Filaggrin- | | | | | | | | | |
| | 2 | | | | | | | | | |
| P08727 | SWISS-PROT: P08727 | 7 | 3 | 5 | 1 | 400 | 44.1 | 5.14 | 10.95 | 3 |
| | Tax_Id = 9606 | | | | | | | | | |
| | Gene_Symbol = KRT19 Keratin, | | | | | | | | | |
| | type I cytoskeletal 19 | | | | | | | | | |
| Q61726 | TREMBL: Q61726 | 3 | 1 | 3 | 1 | 479 | 52.8 | 5.74 | 8.65 | 1 |
| | Tax_Id = I0090 | | | | | | | | | |
| | Gene_Symbol = 5430421N21Ri | | | | | | | | | |
| | k | | | | | | | | | |
| | Keratin type II | | | | | | | | | |
| P20930 | SWISS-PROT: P20930 | 1 | 2 | 2 | 2 | 4061 | 434.9 | 9.25 | 4.56 | 2 |
| | Tax_Id = 9606 | | | | | | | | | |
| | Gene_Symbol = FLG | | | | | | | | | |
| | Filaggrin | | | | | | | | | |
| Q3T052 | TREMBL: Q3T052; Q5EA67 (Bos | 2 | 1 | 2 | 1 | 916 | 101.4 | 6.68 | 4.32 | 1 |
| | taurus) Inter-alpha (Globulin) | | | | | | | | | |
| | inhibitor H4 | | | | | | | | | |
| ENSEMBL: | (Bos taurus) similar to alpha- | 1 | 1 | 1 | 1 | 1477 | 164.2 | 6.02 | 2.96 | 1 |
| ENSBTAP | 2- | | | | | | | | | |
| 00000024146 | macroglobulin isoform 1 | | | | | | | | | |
| Q58D62 | SWISS-PROT: Q58D62 (Bos | 5 | 1 | 1 | 1 | 387 | 42.6 | 5.77 | 2.67 | 1 |
| | taurus) Fetuin-B precursor | | | | | | | | | |

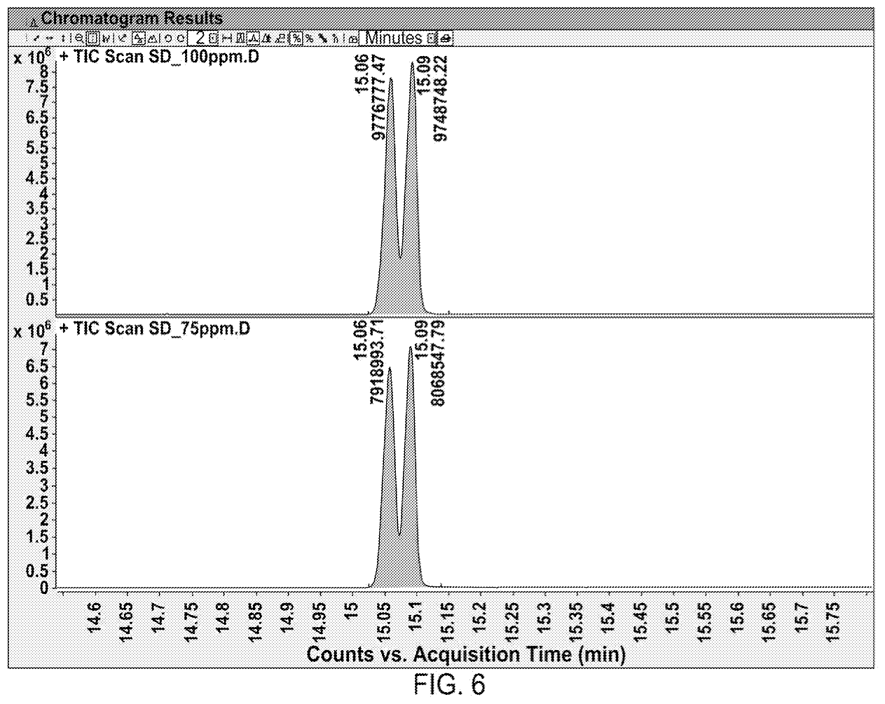

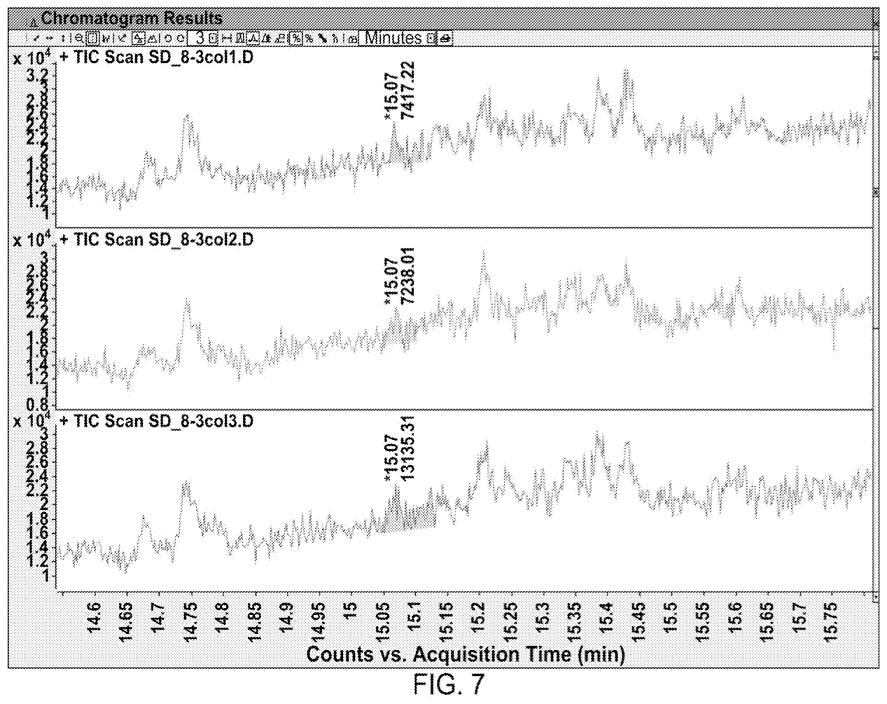

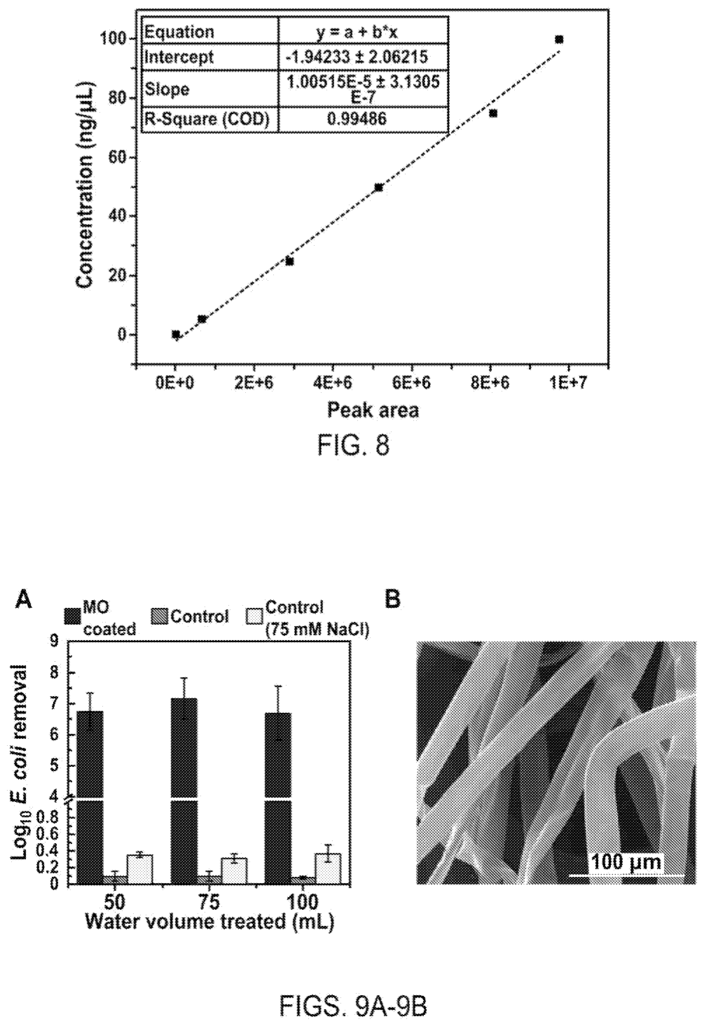

Oil content analysis. Fatty acids in vegetable oils exist in triglyceride molecules, which are not volatile enough to use gas chromatography-mass spectroscopy (GC-MS) for direct analysis. Fatty acid methyl esters (FAMEs) are a common derivative used to convert triglycerides to a molecule better suited for GC-MS analysis [43, 44]. The FAME derivatization protocol used in our work was adapted from O'Fallon et al [45]. For column experiments with oil filtration, all column filtrate (100 mL) was collected and stored for analysis. Oil in water samples first were exposed to a hexane sweep to remove organics from water, followed by saponification and esterification. Addition description of the FAME derivatization and GC-MS method is included in Oil content analysis Supporting Information discussion below. The GC-MS detection limit was determined to be 5 ng/μL for the target compound, methyl oleate. Examples of GC-MS total ion chromatograms are shown in FIGS. 6 and 7, and the standard curve for concentration calibration is shown in FIG. 8.

Oil content analysis Supporting Information. Column filtrate was collected (100 mL) and vortexed before oil content analysis. A hexane sweep was first employed to transfer organics from water to hexane. 4 mL of hexane and 1 mL of 5 mM NaCl solution was added to 25 mL of water/oil emulsion samples, vortexed and centrifuged at 4,500 rpm for 5 minutes at room temperature. The upper layer (hexane) was removed and collected in 40 mL glass vials. A second hexane sweep was employed to further extract remaining organics. Hexane was left overnight to evaporate. To produce free fatty acids from triglycerides in canola oil, a direct FAME synthesis was adapted from O'Fallon et al. First, 5 mL of methanol and 0.7 mL 10 N KOH was added to glass vials and mixed thoroughly. Vials were heated in a water bath for 2 hours at 60° C. with vortex mixing every 15 minutes and then cooled to room temperature. 0.5 mL 18M H₂SO₄ was added to the sample and returned to 60° C. water bath for 2 hours with vortex mixing every 15 minutes. Vial contents were transferred to 50 ml conical tubes and 5 mL hexane was added. Tubes were vortexed and centrifuged at 4,500 rpm for 5 minutes at room temperature. The upper layer (hexane) was removed and transferred to a 40 mL glass vial. The hexane sweep was repeated a second time. The vials were then left overnight for hexane to evaporate. Hexane was then added to the vials to resuspend derivatized FAMEs for GC-MS analysis.

Canola oil is composed of oleic acid (C₁₈H₃₄O₂), linoleic acid (C₁₈H₃₂O₂), and small amounts of other hydrocarbon chains. Methyl oleate and methyl linoleate (Sigma-Aldrich) were used as standards for calibration curves with concentrations from 0-100 ng/μL. The instrument used was an Agilent 5977E Single Quadrupole GC-MS with a 7820A gas chromatograph. A 60-meter DB-1 MS (0.25 mm i.d., 0.25 μm film thickness, part number 122-0162) UI narrow bore column (Agilent) was used with He as the carrier gas. The GC temperature program was held at 40° C. for 1 minute then ramped at 20° C. min-1 to 320° C. and finally held at 320° C. for 10 minutes. The inlet temperature was 280° C. Samples (1 μL) were injected in splitless mode with a flow of 1 mL/min. The total area of the peak corresponding to methyl oleate, eluting at approximately 15.09 min, was integrated. Peak areas of influent and effluent samples were compared to a calibration plot, and the final concentration in samples was calculated based on dilution factors. The detection limit was determined to be 5 ng/μL. Examples of total ion chromatograms (TIC) are included in FIGS. 6 and 7, along with a calibration curve of methyl oleate standard in FIG. 8.

SEM analysis. The morphology of kapok fibers before and after E. coli removal were characterized by scanning electron microscopy (SEM). To preserve and chemically-fix the structures of the specimen, a chemical drying agent (hexamethyldisilazane, HMDS procured form Electron Microscopy Sciences, PA), used commonly to dehydrate soft tissues and

biological molecules prior to the examination by SEM, was used [46]. Briefly, the specimens to be examined were dehydrated through varying concentrations of graded ethanol (30%, 50%, 60%, 70%, 80%, 90% and 100% ethanol for 10 min each) and then maintained in 50% ethanol/HMDS and 100% HMDS for 2 min each in succession at room temperature prior to drying at room temperature in air overnight. HMDS dried specimens were coated with a thin gold/palladium (Au/Pd) layer using an EMS Sputter Coater to prevent static charge accumulation and images were acquired using Quanta 650 ESEM (FEI) at an acceleration voltage of 5 kV to 15 kV.

### Results/Discussion

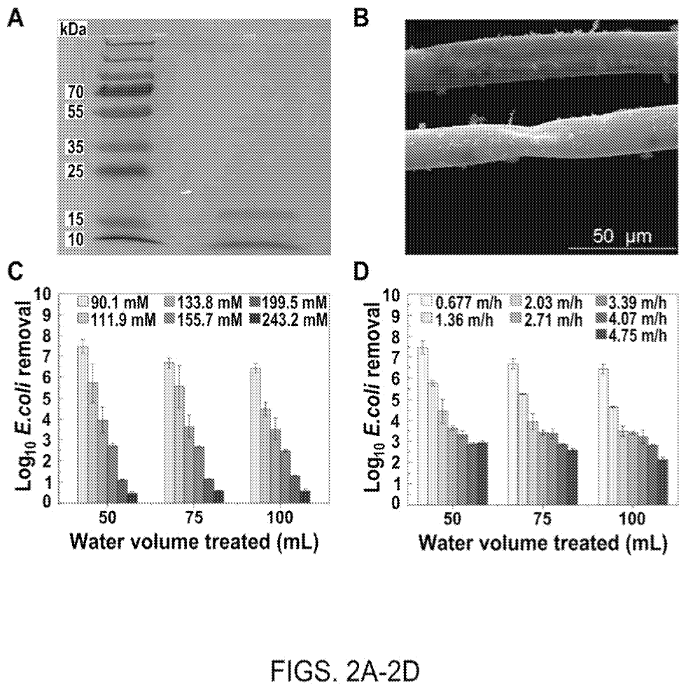

Protein adsorption to kapok fibers and E. coli removal. Initial E. coli removal experiments maintained low (15 mM ionic strength) salinity and low (0.677 m/h) loading rate (FIG. 9A). Protein adsorption to kapok fibers was evaluated through SDS-PAGE analysis (FIG. 2A), adsorbed protein quantification, and E. coli removal (FIG. 2B). Liquid chromatography-mass spectrometry (Table 1) confirmed the presence of MO proteins adsorbing to kapok fibers. The protein concentration in 600 mM NaCl wash from the fluorometric assay was 8.64±0.51 mg, resulting in an average of 4.32 mg protein/g fiber. In previous work with MO-coated sand filters, the electrostatic interaction between negatively charged “sand” particles (silica beads) and cationic peptides provided the mechanism for protein adsorption [30, 31]. In this work, it was surprisingly shown that MO proteins could adsorb to the hydrophobic, waxy coating on kapok fibers, based on E. coli adsorption shown in FIG. 2B. An SEM image of kapok before E. coli removal is shown in FIG. 9B.

E. coli removal decreases as salinity increases, but a high rate of removal persists. PW salinities vary based on extraction method and geographic location but can be anywhere from a few parts per million (ppm or mg/L) to greater than 100,000 mg/L [1, 10]. In the Permian basin, the Delaware, Devonian, and Leonardian region PWs salinity is less than 8,000 mg/L TDS [47]. In order to understand how E. coli removal would be affected in saline conditions similar to those in the low TDS range of PW, experiments were performed with different TDS concentrations at a constant flowrate of 2 mL/min (0.677 m/h). The results, shown in FIG. 2C, show that the removal at low ionic strength is high at approximately 7-log removal, and as the TDS (and thus the ionic strength) increases, the E. coli removal declines. However, greater than 99% removal persists at 155.7 mM ionic strength (9,076 mg/L TDS). Previous work has shown the interaction between MO2.1 and E. coli is primarily electrostatic [28]. Thus, a large decrease in removal was shown partially because of increasing ionic strength, which decreases the Debye length surrounding charged particles [48]. The high removal seen at high ionic strengths indicates that this highly effective filter can still operate at high TDS values.

3-log (99.9%) E. coli removal is achieved at filter loading rates approaching the rapid sand filtration range. In previous work with MO-coated sand filters [30, 31], filter loading rates were quite low and typical of that expected from slow sand filtration (0.1-0.4 m/h [49]). Typical rapid sand filtration (RSF) operates anywhere from 5-15 m/h and is a preferred mode of operation for cost and practical implementation. We investigated flowrates approaching RSF range and results indicate that increasing flowrate decreases E. coli removal but remains around 3-log removal at flowrates near RSF range (FIG. 2D). Without attempting to be bound by theory, the decrease may be due to the decrease in contact time between the E. coli solution and adsorbed MO proteins with increase in loading rate.

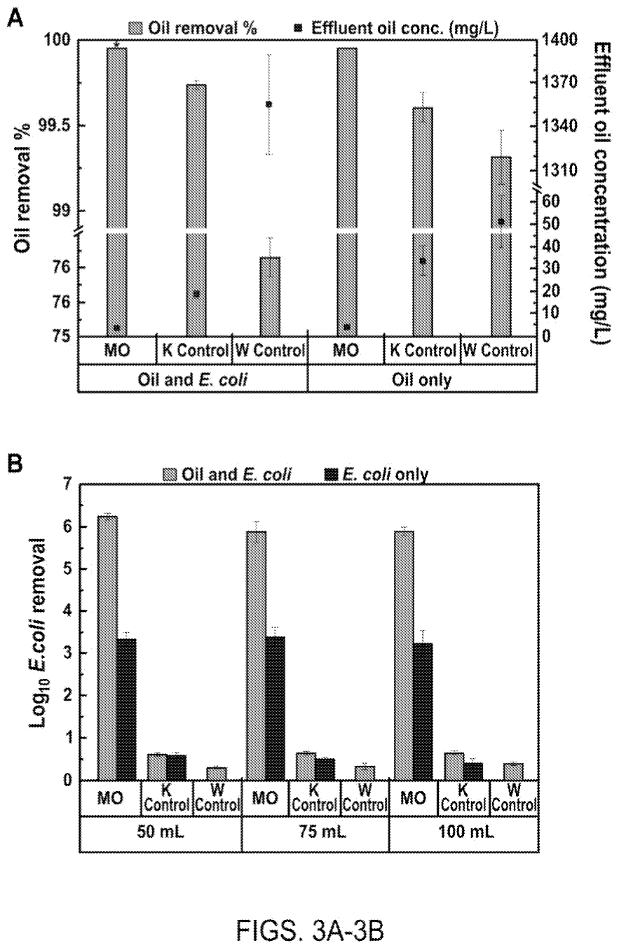

Kapok fiber filters achieve 99.6% removal of oil from oil-in-water emulsions. The waxy coating on kapok fibers allows for hydrophobic interaction and oil sorption as shown in previous static oil sorption studies [23, 24, 51, 52]. In the filtration tests we conducted with 1% (w/w) oil-in-water emulsions through kapok fiber filters, 99.6% of canola oil in water was removed. Filtration using kapok fibers is not extensively reported in literature, but some studies exist for oil/water separations [25, 53, 54]. Similar oil removal for kapok filters has been achieved for diesel oil (greater than 99% removal [25, 53, 54]), hydraulic oil (99.6% removal [25]), and vegetable oil (greater than 99% removal [53]). The filtrate from control (uncoated) kapok filters has an average effluent concentration of 33.7 mg/L oil, as shown in FIG. 3A, providing sufficient removal to satisfy the EPA discharge regulation.

WS media filters provide 99.3% oil removal. WS media has been well-studied as an oil sorbent [36, 55, 56] and is commonly employed in produced water treatment to remove oil [33, 57]. WS media removed 99.3% of oil from the oil-in-water emulsion (FIG. 3A), corresponding to an average effluent concentration of 51.1 mg/L oil, when filtering oil only. This does not meet the EPA produced water discharge regulation of 48 mg/L oil and grease [58], so WS filters alone are not sufficient to treat oily water.

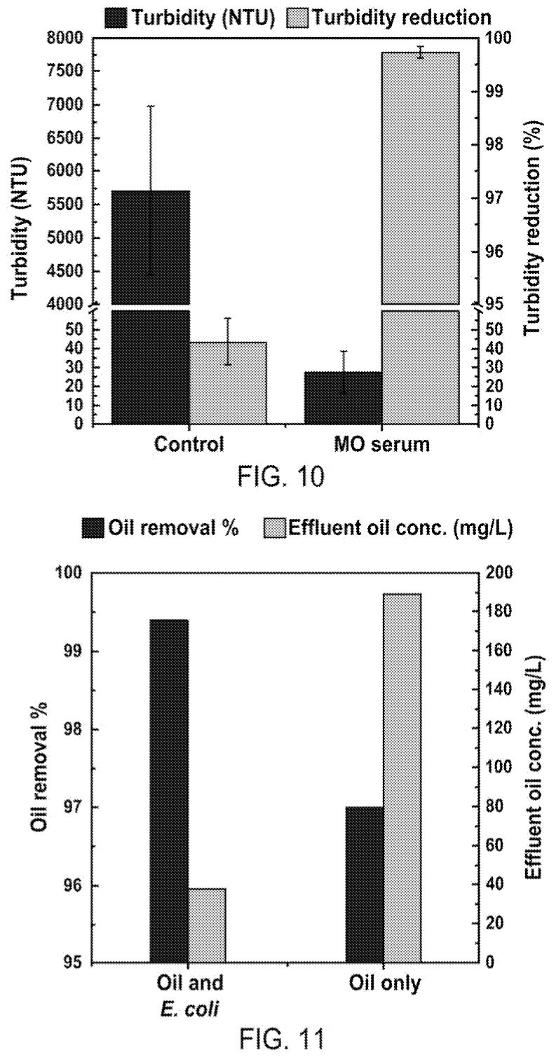

MO-coated kapok fiber filters show enhanced oil removal. When kapok fibers were coated with MO proteins, oil removal was increased to >99.95% which correlates to an effluent concentration of less than 4 mg/L (FIG. 3A). Canola oil is composed primarily of triacylglycerols with around 1% free fatty acids (FFAs) [59]. Therefore, the interaction between kapok and oil is predominantly hydrophobic. Under experimental conditions of an approximate pH of 7, FFAs of canola oil (oleic acid 62%, linoleic acid 20%, alpha linoleic acid 9%) [60] exist in the deprotonated form (pKas of 5.02 and 4.77) [61], revealing a negatively charged region. MO proteins, specifically MO2.1, have been shown to possess flocculating activity due to the presence of several positively charged residues on the protein [62]. An electrostatic interaction between deprotonated FFAs and cationic MO proteins may explain the slight increase in oil removal when MO protein is present on kapok fibers. A jar test experiment was conducted to determine the MO serum flocculating capacity for the canola oil/water emulsion, and results showed greater than 99% reduction of turbidity (due to oil) in the suspensions where MO serum was added (FIG. 10). Electrostatic attraction, coupled with hydrophobic interaction between oil and MO proteins, may have contributed to the decrease in turbidity of the oil/water emulsion.

WS media provides low oil and low bacteria removal when filtered simultaneously. WS oil removal decreased to 77.3% when bacteria and oil were filtered simultaneously. In addition, WS provided very little bacteria removal (0.29-log removal), which is less than control kapok bacteria removal (0.59-log removal). The corresponding effluent oil concentration is 1,355 mg/L, which does not satisfy EPA discharge regulations and would require further treatment.

Functionalized kapok fibers achieve simultaneous 6-log (99.9999%) E. coli removal and >99.95% oil removal under moderately saline conditions. Functionalized kapok columns achieve 5-6 log (99.999-99.9999%) removal of E. coli and >99.95% of oil with TDS concentration 5,237 mg/L at a loading rate of 3.39 m/h. Interestingly, at 3.39 m/h E. coli removal in the presence of oil is higher compared to the removal without oil (FIG. 3B). The addition of E. coli in oil/water emulsions has been shown to coalesce oil and cause clustering among droplets, suggesting bridging between emulsion droplets [63]. This may allow for a hydrophobic interaction between bacterial cell membranes and oil, creating larger negatively charged particles that interact with cationic MO proteins. This could explain the increase in E. coli removal as more bacteria cells interact with oil and MO proteins resulting in their retention on the filter. Control columns do not provide high E. coli removal but are able to provide high oil removal with E. coli present (99.74%) and without E. coli present (99.6%). This slight increase in oil removal when bacteria is present may be explained by the coalescence of oil in the presence of bacteria [63]. This work reveals the importance of MO proteins in increasing E. coli removal of kapok filters during simultaneous filtration. In comparison, GAC can remove up to 1-log of E. coli and provide 90% oil removal [65], while no work has reported on simultaneous removal. Microfiltration membranes for oil and bacteria separation from water demonstrated 85% oil rejection and 2-log E. coli rejection [66]. An overview of current technologies for oil and bacteria removal from produced water is shown in Table 2. Compared to similar technologies, functionalized kapok filters show increased removal for both oil and bacteria under close to rapid sand filtration operating conditions.

TABLE 2
Overview of current technologies to remove oil and bacteria

| | Loading | | Feed solution | Bacteria | Oil | |
|---|---|---|---|---|---|---|
| Technology | rate | | salinity | removal | removal | Source |
| Microfiltration | 0.4536 | m/h | 150 mM for | 2-log | 85% | [3]* |
| | | | bacteria, DI | | | |
| | | | water for oil | | | |
| Ultrafiltration | 0.02 | m/h | 11 mg/L TDS | — | 98% | [4] |
| | 0.06-0.14 | m/h | 265 S/cm | 2-log | — | [5] |
| | | | conductivity | | | |
| Membrane | 0.025 | m/h | — | 6.1-log | — | [6] |
| bioreactor | 0.01 | m/h | 8,367 mg/L TDS | — | 60-85% | [7] |
| Granular | 0.159 | m/h | DI water | — | 90% | [8] |
| activated | 5 | m/h | 44.8 mS/m | 1.1-log | — | [9] |
| carbon (GAC) | | | conductivity | | | |
| filter | | | | | | |
| Walnut shell | 0.573 | m/h | 9,374 mg/L TDS | — | 38% | [10] |
| filter | | | | | | |
| | 28.11 | m/h | Fresh water | — | >95% | [11] |
| | | | (0% salinity) | | | |
| | 3.39 | m/h | 90.1 mM ionic | 0.29-log** | 77.3% | Presented in |
| | | | strength | | | this work |
| Kapok fiber | 3.39 | m/h | 90.1 mM ionic | 0.59-log** | 99.6% | Presented in |
| filter | | | strength | | | this work |

| | | |
|---|---|---|
| MO-coated | 6.24-log** | >99.95% |
| kapok fiber | | |
| filter | | |

*Indicates filtration of bacteria and oil was not simultaneous
**Indicates average bacteria removal value for 50 mL volume of water treated

### Mo Serum Coagulation/Flocculation of Oil/Water Emulsion

MO serum was investigated for its coagulation and flocculation of oil in the characteristic influent used in this work. MO proteins, specifically MO2.1, have been shown to possess flocculating activity due to the high positively charged regions on the protein [46]. A simple jar test experiment was conducted to determine the MO serum flocculating capacity for the canola oil/water emulsion, and results showed greater than 99% reduction of turbidity in the suspensions where MO serum was added (FIG. 6). All experiments were conducted at a pH of approximately 7. Under these conditions, canola oil components (oleic acid 62%, linoleic acid 20%, alpha linoleic acid 9%) exist in the deprotonated form (pKas of 5.02, 4.77) [58], revealing a negatively charged region that may be electrostatically attracted to cationic MO proteins.

### Oil Removal

97% of canola oil in water is removed via kapok filters as shown in FIG. 11. Vegetable oil has been shown to possess a high adhesive energy to kapok fiber, likely due to van der Waals forces and hydrophobic interaction between the oil and plant wax, which could contribute to its favorable interaction in oily water filtration [38].

### Simultaneous Oil and E. Coli Removal

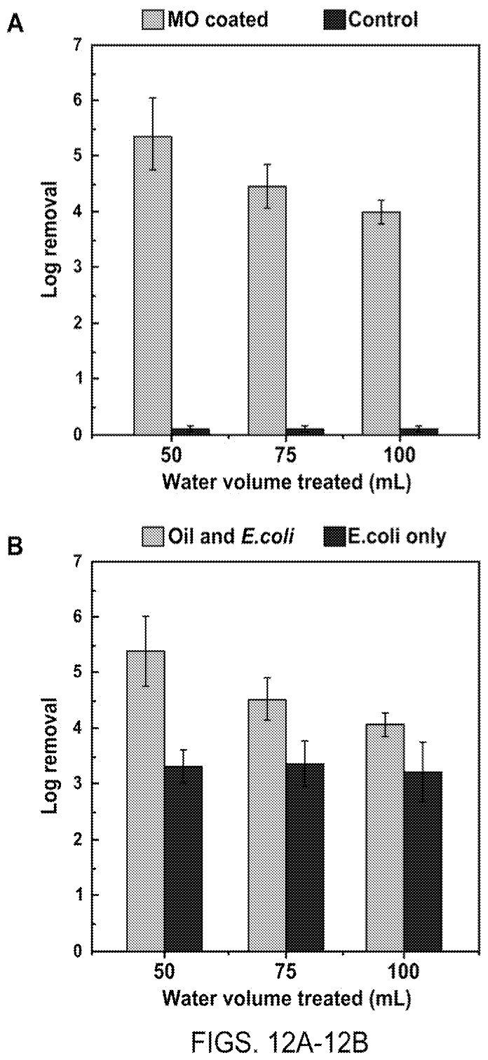

Functionalized kapok columns in this example achieved 4-5 log (99.99-99.999%) removal of E. coli and >99.4% of oil (FIGS. 11 and 12A) with TDS concentration 5,315 mg/L at a loading rate of 3.39 m/h. Control columns do not provide any significant E. coli removal (FIG. 12A) but are able to provide similar oil removal (97%) to uncoated kapok when E. coli is not present. Compared to similar technologies, functionalized kapok filters show increased removal for both oil and bacteria. The simultaneous capability of this filter can combine water treatment processes with different goals (bacteria reduction, oil removal) into one natural and sustainable technology.

Interestingly, at 3.39 m/h E. coli removal in the presence of oil is higher compared to the removal without oil (FIG. 12B). This may be due to a hydrophobic interaction between bacterial cell membranes and canola oil. The presence of E. coli in surfactant emulsions has been shown to coalesce surfactant and cause clustering among droplets, suggesting bridging between emulsion droplets [59]. This could explain the increase in E. coli removal as cells interact with oil.

MO-coated kapok filters provide a sustainable option for oily wastewater treatment. MO-coated filters can simultaneously remove high amounts of bacteria and oil at a moderate salinity and a loading rate approaching RSF. This filter combines traditionally separate water treatment processes (disinfection and organics removal) into one natural and sustainable technology. While MO-coated kapok can treat higher salinity waters such as PW, it can also act as an oily wastewater technology for contamination mitigation, POU filters for disinfection, membrane pretreatment, and emergency water supply filters for waters with lower salinity. Overall, MO-coated kapok filters improve upon existing oil/water separation technology by providing concurrent removal of oil and E. coli while being comprised of completely plant-based components.

### EXAMPLE 1 REFERENCES

[1] A. Fakhru'l-Razi, A. Pendashteh, L. C. Abdullah, D. R. A. Biak, S. S. Madaeni, and Z. Z. Abidin, “Review of technologies for oil and gas produced water treatment,” Journal of Hazardous Materials, vol. 170, no. 2, pp. 530-551, 2009 Oct. 30, 2009, doi: doi.org/10.1016/j.jhazmat.2009.05.044.
[2] J. D. Arthur, B. G. Langhus, and C. Patel, “Technical summary of oil & gas produced water treatment technologies,” All Consulting, LLC, Tulsa, OK, 2005.
[3] P. F. Sanders and P. J. Sturman, “Biofouling in the Oil Industry,” in Petroleum Microbiology, 2005, pp. 171-198.
[4] M. A. Reinsel, J. T. Sears, P. S. Stewart, and M. J. McInerney, “Control of microbial souring by nitrate, nitrite or glutaraldehyde injection in a sandstone column,” Journal of Industrial Microbiology and Biotechnology, vol. 17, no. 2, pp. 128-136, 1996, doi: 10.1007/bf01570056.
[5] M. Nemati, G. E. Jenneman, and G. Voordouw, “Impact of Nitrate-Mediated Microbial Control of Souring in Oil Reservoirs on the Extent of Corrosion,” Biotechnology Progress, vol. 17, no. 5, pp. 852-859, 2001, doi: doi.org/10.1021/bp010084v.
[6] H. Liu et al., “Corrosion behavior of carbon steel in the presence of sulfate reducing bacteria and iron oxidizing bacteria cultured in oilfield produced water,” Corrosion Science, vol. 100, pp. 484-495, 2015 Nov. 1, 2015, doi: doi.org/10.1016/j.corsci.2015.08.023.
[7] E. Hill, J. Shennan, and R. Watkinson, Microbial problems in the offshore oil industry. John Wiley & Sons Incorporated, 1987.
[8] S. Jiménez, M. M. Micó, M. Arnaldos, F. Medina, and S. Contreras, “State of the art of produced water treatment,” Chemosphere, vol. 192, pp. 186-208, 2018 Feb. 1, 2018, doi: doi.org/10.1016/j.chemosphere.2017.10.139.
[9] M. A. Al-Ghouti, M. A. Al-Kaabi, M. Y. Ashfaq, and D. A. Da′na, “Produced water characteristics, treatment and reuse: A review,” Journal of Water Process Engineering, vol. 28, pp. 222-239, 2019.
[10] S. Adham, A. Hussain, J. Minier-Matar, A. Janson, and R. Sharma, “Membrane applications and opportunities for water management in the oil & gas industry,” Desalination, vol. 440, 2-17, 2018 Aug. 15/pp. 2018, doi: doi.org/10.1016/j.desal.2018.01.030.
[11] S. Alzahrani and A. W. Mohammad, “Challenges and trends in membrane technology implementation for produced water treatment: A review,” Journal of Water Process Engineering, vol. 4, pp. 107-133, 2014.
[12] P. Le-Clech, V. Chen, and T. A. Fane, “Fouling in membrane bioreactors used in wastewater treatment,” Journal of membrane science, vol. 284, no. 1-2, pp. 17-53, 2006.
[13] M. Zoubeik, M. Ismail, A. Salama, and A. Henni, “New developments in membrane technologies used in the treatment of produced water: A review,” Arabian Journal for Science and Engineering, vol. 43, no. 5, pp. 2093-2118, 2018.
[14] H.-C. Flemming, “Reverse osmosis membrane biofouling,” Experimental Thermal and Fluid Science, vol. 14, no. 4, pp. 382-391, 1997 May 1/1997, doi: doi.org/10.1016/S0894-1777 (96) 00140-9.
[15] H.-C. Flemming, “Microbial Biofouling: Unsolved Problems, Insufficient Approaches, and Possible Solutions,” vol. 5, 2011, pp. 81-109.
[16] N. Porcelli and S. Judd, “Chemical cleaning of potable water membranes: A review,” Separation and Purification Technology, vol. 71, no. 2, pp. 137-143, 2010 Feb. 18, 2010, doi: doi.org/10.1016/j.seppur.2009.12.007.
[17] J. Yin, Y. Yang, Z. Hu, and B. Deng, “Attachment of silver nanoparticles (AgNPs) onto thin-film composite (TFC) membranes through covalent bonding to reduce membrane biofouling,” Journal of Membrane Science, vol. 441, pp. 73-82, 2013 Aug. 15, 2013, doi: doi.org/10.1016/j.memsci.2013.03.060.
[18] M. Ben-Sasson, K. R. Zodrow, Q. Genggeng, Y. Kang, E. P. Giannelis, and M. Elimelech, “Surface Functionalization of Thin-Film Composite Membranes with Copper Nanoparticles for Antimicrobial Surface Properties,” Environmental Science & Technology, vol. 48, no. 1, pp. 384-393, 2014 Jan. 7 2014, doi: 10.1021/es404232s.
[19] S. Meng, Y. Ye, J. Mansouri, and V. Chen, “Fouling and crystallisation behaviour of superhydrophobic nano-composite PVDF membranes in direct contact membrane distillation,” Journal of Membrane Science, vol. 463, pp. 102-112, 2014 Aug. 1, 2014, doi: doi.org/10.1016/j.memsci.2014.03.027.
[20] Y. Liao, G. Zheng, J. J. Huang, M. Tian, and R. Wang, “Development of robust and superhydrophobic membranes to mitigate membrane scaling and fouling in membrane distillation,” Journal of Membrane Science, vol. 601, p. 117962, 2020 Mar. 1, 2020, doi: doi.org/10.1016/j.memsci.2020.117962.
[21] F. P. Byrne et al., “Tools and techniques for solvent selection: green solvent selection guides,” Sustainable Chemical Processes, vol. 4, no. 1, p. 7, 2016 May 23 2016, doi: 10.1186/s40508-016-0051-z.
[22] “Kapok Tree.” Rainforest Alliance. www.rainforest-alliance.org/species/kapok-tree (accessed Dec. 7, 2020.
[23] J. Wang, Y. Zheng, and A. Wang, “Effect of kapok fiber treated with various solvents on oil absorbency,” Industrial crops and products, vol. 40, pp. 178-184, 2012.
[24] M. A. Abdullah, A. U. Rahmah, and Z. Man, “Physicochemical and sorption characteristics of Malaysian Ceiba pentandra (L.) Gaertn. as a natural oil sorbent,” Journal of Hazardous Materials, vol. 177, no. 683-691, 2010 May 15/pp. 2010, doi: 1, doi.org/10.1016/j.jhazmat.2009.12.085.
[25] X. Huang and T.-T. Lim, “Performance and mechanism of a hydrophobic-oleophilic kapok filter for oil/water separation,” Desalination, vol. 190, no. 1-3, pp. 295-307, 2006.
[26] A. T. A. Baptista et al., “Coagulation-flocculation process with ultrafiltered saline extract of Moringa oleifera for the treatment of surface water,” Chemical Engineering Journal, vol. 276, pp. 166-173, 2015 Sep. 15, 2015, doi: doi.org/10.1016/j.cej.2015.04.045.
[27] A. M. S. Vieira et al., “Use of Moringa oleifera Seed as a Natural Adsorbent for Wastewater Treatment,” Water, Air, and Soil Pollution, vol. 206, no. 1, pp. 273-281, 2010 Feb. 1 2010, doi: 10.1007/s11270-009-0104-y.
[28] K. Shebek, A. B. Schantz, I. Sines, K. Lauser, S. Velegol, and M. Kumar, “The Flocculating Cationic Polypetide from Moringa oleifera Seeds Damages Bacterial Cell Membranes by Causing Membrane Fusion,” Langmuir, vol. 31, no. 15, pp. 4496-502, Apr. 21 2015, doi: 10.1021/acs.langmuir.5b00015.
[29] J. Rockwood, B. Anderson, and D. Casamatta, “Potential uses of Moringa oleifera and an examination of antibiotic efficacy conferred by M. oleifera seed and leaf extracts using crude extraction techniques available to underserved indigenous populations,” International Journal of Phytotherapy Research, vol. 3, no. 2, pp. 61-71, 2013.
[30] L. Samineni et al., “7 Log Virus Removal in a Simple Functionalized Sand Filter,” Environ Sci Technol, vol. 53, no. 21, pp. 12706-12714, Nov. 5 2019, doi: 10.1021/acs.est. 9b03734.
[31] B. Xiong et al., “Moringa oleifera f-sand Filters for Sustainable Water Purification,” Environmental Science & Technology Letters, vol. 5, no. 1, pp. 38-42, 2018 Jan. 9 2018, doi: 10.1021/acs.estlett.7b00490.
[32] S. V R. C. Board. “GROUNDWATER INFORMATION SHEET.” www.waterboards.ca.gov/gama/docs/coc_salinity.pdf (accessed Apr. 20 2021.
[33] C. H. Rawlins and F. Sadeghi, “Experimental study on oil removal in nutshell filters for produced-water treatment,” SPE Production & Operations, vol. 33, no. 01, pp. 145-153, 2018.
[34] E. T. Igunnu and G. Z. Chen, “Produced water treatment technologies,” International Journal of Low-Carbon Technologies, vol. 9, no. 3, pp. 157-177, 2012, doi: 10.1093/ijlct/cts049.
[35] X.-q. Yin, J. Zhang, X. Wang, and M. Zhu, “Modified walnut shell filter material for the enhanced removal of oil from oilfield wastewater,” Environmental Engineering Research, vol. 26, 2020.
[36] Z. Z. Ismail, “Removal of oil from wastewater using walnut-shell,” Al-Khwarizmi engineering journal, vol. 1, no. 1, pp. 117-124, 2005.
[37] D. J. Miller, S. Kasemset, D. R. Paul, and B. D. Freeman, “Comparison of membrane fouling at constant flux and constant transmembrane pressure conditions,” Journal of Membrane Science, vol. 454, pp. 505-515, 2014.
[38] P. H. H. Duong, T.-S. Chung, S. Wei, and L. Irish, “Highly Permeable Double-Skinned Forward Osmosis Membranes for Anti-Fouling in the Emulsified Oil-Water Separation Process,” Environmental Science & Technology, vol. 48, no. 8, pp. 4537-4545, 2014 Apr. 15 2014, doi: 10.1021/es405644u.
[39] T. L. Wood, R. Guha, L. Tang, M. Geitner, M. Kumar, and T. K. Wood, “Living biofouling-resistant membranes as a model for the beneficial use of engineered biofilms,” Proceedings of the National Academy of Sciences, vol. 113, no. 20, p. E2802, 2016, doi: 10.1073/pnas. 1521731113.
[40] T. L. Wood, R. Guha, L. Tang, M. Geitner, M. Kumar, and T. K. Wood, “Living biofouling-resistant membranes as a model for the beneficial use of engineered biofilms,” Proceedings of the National Academy of Sciences, vol. 113, no. 20, pp. E2802-E2811, 2016, doi: 10.1073/pnas. 1521731113.
[41] G. W. Claus, Understanding microbes: a laboratory textbook for microbiology. Macmillan, 1989.
[42] B. A. Nordmark et al., “Moringa oleifera Seed Protein Adsorption to Silica: Effects of Water Hardness, Fractionation, and Fatty Acid Extraction,” Langmuir, vol. 34, no. 16, pp. 4852-4860, 2018.
[43] E. Tammekivi et al., “Comparison of derivatization methods for the quantitative gas chromatographic analysis of oils,” Analytical Methods, vol. 11, no. 28, pp. 3514-3522, 2019.
[44] M. C. Milinsk, M. Matsushita, J. V. Visentainer, C. C. d. Oliveira, and N. E. d. Souza, “Comparative analysis of eight esterification methods in the quantitative determination of vegetable oil fatty acid methyl esters (FAME),” Journal of the Brazilian Chemical Society, vol. 19, pp. 1475-1483, 2008.
[45] J. V. O'Fallon, J. R. Busboom, M. L. Nelson, and C. T. Gaskins, “A direct method for fatty acid methyl ester synthesis: Application to wet meat tissues, oils, and feedstuffs,” Journal of Animal Science, vol. 85, no. 6, pp. 1511-1521, 2007, doi: 10.2527/jas.2006-491.
[46] J. L. Nation, “A New Method Using Hexamethyldisilazane for Preparation of Soft Insect Tissues for Scanning Electron Microscopy,” Stain Technology, vol. 58, no. 6, pp. 347-351, 1983 Jan. 1 1983, doi: 10.3109/10520298309066811.
[47] B. K. Chaudhary, R. Sabie, M. A. Engle, P. Xu, S. Willman, and K. C. Carroll, “Spatial variability of produced-water quality and alternative-source water analysis applied to the Permian Basin, USA,” Hydrogeology Journal, vol. 27, no. 8, pp. 2889-2905, 2019 Dec. 1 2019, doi: 10.1007/s10040-019-02054-4
[48] M. M. B. Desmond F Lawler, Water Quality Engineering. Wiley, 2013.
[49] L. Huisman and W. E. Wood, Slow sand filtration. World Health Organization, 1974.
[50] J. C. Crittenden et al., MWH's Water Treatment: Principles and Design. Hoboken, UNITED STATES: John Wiley & Sons, Incorporated, 2012.
[51] K. Hori, M. E. Flavier, S. Kuga, T. B. T. Lam, and K. Iiyama, “Excellent oil absorbent kapok [Ceiba pentandra (L.) Gaertn.] fiber: fiber structure, chemical characteristics, and application,” Journal of Wood Science, vol. 46, no. 5, pp. 401-404, 2000 Oct. 1 2000, doi: 10.1007/BF00776404.
[52] T.-T. Lim and X. Huang, “Evaluation of kapok (Ceiba pentandra (L.) Gaertn.) as a natural hollow hydrophobic-oleophilic fibrous sorbent for oil spill cleanup,” Chemosphere, vol. 66, no. 5, pp. 955-963, 2007 Jan. 1, 2007, doi: doi.org/10.1016/j.chemosphere.2006.05.062.
[53] T. Dong, S. Cao, and G. Xu, “Highly efficient and recyclable depth filtrating system using structured kapok filters for oil removal and recovery from wastewater,” Journal of Hazardous Materials, vol. 321, pp. 859-867, 2017 Jan. 5, 2017, doi: doi.org/10.1016/j.jhazmat.2016.10.005.
[54] T.-T. Lim and X. Huang, “Evaluation of hydrophobicity/oleophilicity of kapok and its performance in oily water filtration: comparison of raw and solvent-treated fibers,” Industrial Crops and Products, vol. 26, no. 2, pp. 125-134, 2007.
[55] A. Srinivasan and T. Viraraghavan, “Oil removal from water using biomaterials,” Bioresource Technology, vol. 101, no. 17, pp. 6594-6600, 2010 Sep. 1, 2010, doi: doi.org/10.1016/j.biortech.2010.03.079.
[56] A. Srinivasan and T. Viraraghavan, “Removal of oil by walnut shell media,” Bioresource Technology, vol. 99, 17, no pp. 8217-8220, 2008 Nov. 1, 2008, doi: doi.org/10.1016/j.biortech.2008.03.072.
[57] D. Robinson, “Oil and gas: Treatment of produced waters for injection and reinjection,” Filtration+Separation, vol. 50, no. 4, pp. 36-43, 2013 Jul. 1, 2013, doi: doi.org/10.1016/S0015-1882 (13) 70168-X.
[58] U.S. EPA. Electronic Code of Federal Regulations; Title 40: Protection of Environment; PART 435 OIL AND GAS EXTRACTION POINT SOURCE CATEGORY § 435.12. [Online] Available: www.ecfr.gov/cgi-bin/text-idx?SID=fbb8f7eed8f4e4ccf2e5ffee8e8705d6&mc=true&node-pt40.32.435&rgn-div5 #s e40.32.435_132
[59] F. Gunstone, Vegetable oils in food technology: composition, properties and uses. John Wiley & Sons, 2011.
[60], “Vegetable Oils,” in Bailey's Industrial Oil and Fat Products, vol. 1, F. Shahidi Ed., 6th ed. ed. (Edible Oil and Fat Products: Chemistry, Properties, and Health Effects. Hoboken, NJ: Wiley, 2005, pp. 213-267.
[61] J. A. Riddick, W. B. Bunger, and T. K. Sakano, Organic solvents: physical properties and methods of purification. Fourth edition. John Wiley and Sons, New York, NY, 1986, p. Medium: X; Size: Pages: 1343.
[62] M. Broin, C. Santaella, S. Cuine, K. Kokou, G. Peltier, and T. Joët, “Flocculent activity of a recombinant protein from Moringa oleifera Lam. seeds,” Applied Microbiology and Biotechnology, vol. 60, no. 1, pp. 114-119, 2002 Oct. 1 2002, doi: 10.1007/s00253-002-1106-5.
[63] J. Li, D. J. Mcclements, and L. A. Mclandsborough, “Interaction between Emulsion Droplets and Escherichia coli Cells,” Journal of Food Science, vol. 66, no. 4, pp. 570-657, 2001, doi: doi.org/10.1111/j.1365-2621.2001.tb04603.x.
[64] W. Hijnen, G. Suylen, J. Bahlman, A. Brouwer-Hanzens, and G. Medema, “GAC adsorption filters as barriers for viruses, bacteria and protozoan (oo) cysts in water treatment,” Water Research, vol. 44, no. 4, pp. 1224-1234, 2010.
[65] Y.-B. Zhou, X.-Y. Tang, X.-M. Hu, S. Fritschi, and J. Lu, “Emulsified oily wastewater treatment using a hybrid-modified resin and activated carbon system,” Separation and Purification Technology, vol. 63, no. 2, pp. 400-406, 2008 Oct. 22, 2008, doi: doi.org/10.1016/j.seppur.2008.06.002.
[66] D. Vasanth, G. Pugazhenthi, and R. Uppaluri, “Fabrication and properties of low cost ceramic microfiltration membranes for separation of oil and bacteria from its solution,” Journal of Membrane Science, vol. 379, no. 1, pp. 154-163, 2011 Sep. 1, 2011, doi: doi.org/10.1016/j.memsci.2011.05.050.

### Example 2: Removal of PFAS Using Moringa Oleifera Proteins

Per- and polyfluoroalkyl substances (PFAS) are highly stable fluorinated substances with surfactant properties, leading to their use in many commercial and industrial applications [1], such as aqueous fire-fighting foams (AFFF) [2], textiles [3], and food packaging [4]. The use of PFAS in AFFF and other industrial applications has led to widespread surface water and groundwater contamination [5, 6]. PFAS-containing products are often discarded in landfills, leading to PFAS-contaminated landfill leachate that can impact nearby water supplies [7, 8]. The highly stable multiple C—F bonds render PFAS impervious to environmental degradation [9]. Because of PFAS compounds' high stability and recalcitrance to various forms of degradation, they are persistent in the environment [10, 11].

A wide range of PFAS concentrations has been found in surface and groundwater, normally in the ng/L range [12]. However, concentrations in contaminated groundwaters can exceed 10-30 μg/mL [13]. PFAS have been detected even in remote areas, such as the Arctic, suggesting the long-range transport of these chemicals [14, 15]. Beyond PFAS presence in water, the chemicals have also been detected in human blood, breast milk, and wildlife [16-18]. A report from the US Center for Disease Control (CDC) reported that almost all Americans have PFAS in their blood [19].

Drinking water is often the main exposure route for human consumption of PFAS, but it can also occur through ingestion of food and inhalation of dust particles [20]. PFAS consumption is a significant concern because of the potential adverse health effects on humans and wildlife, including associations with cancer and endocrine disruption [21-24]. PFAS' interaction with several types of serum albumin proteins has been studied [25, 26], and PFAS have been found to accumulate in protein-rich organs (liver and kidney) [27, 28]. Furthermore, PFAS are lipophilic and can partition into lipid bilayers, resulting in altered cell function [29, 30]. Due to rising concern over PFAS consumption and subsequent health effects, the US Environmental Protection Agency (EPA) has published strict health advisory levels for the two most ubiquitous PFAS, perfluorooctanoic acid (PFOA) and perfluorooctanesulfonic acid (PFOS) [31, 32].

Conventional drinking water treatment (DWT) processes are ineffective at PFAS removal [33, 34]. Specifically, coagulation with ferric chloride and alum have been shown to remove about 20% of PFOA and PFOS [35, 36]. Effective full-scale technologies to remove PFAS from water primarily focus on granular activated carbon (GAC) and anion exchange resin (AER) adsorption [37]. AER targets both the charged head group and hydrophobic tail of PFAS with ion exchange sites and the hydrophobic backbone of the resin, respectively [38]. GAC is further susceptible to microbial contamination within the carbon bed, which can potentiate the presence of microbial and nonmicrobial contaminates downstream. However, these technologies are not included in conventional DWT [39]. Therefore, improving PFAS removal in conventional DWT remains challenging.

Moringa oleifera (MO) is a tree native to India and spread throughout the world in semi-tropic climates. MO seeds have been used as a natural coagulant in water clarification to reduce turbidity [40, 41]. The primary coagulation agent is thought to be cationic proteins present in MO seeds [42, 43]. This work uses PFAS' anionic charge and high protein affinity to improve PFAS treatment using cationic MO proteins. MO proteins are shown to interact with PFOA and PFOS due to a unique interaction. As described below, high PFAS removal can be effectively implemented using sustainable natural fiber filters.

### Materials and Methods

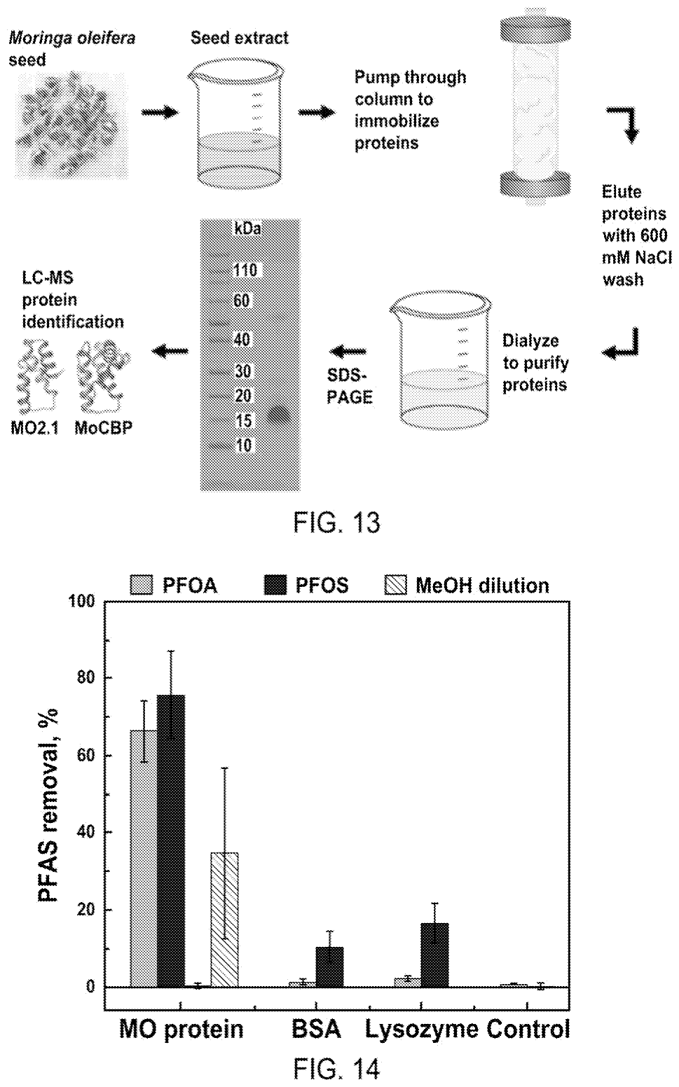

Moringa oleifera (MO) protein purification. Cationic proteins from MO seeds have been shown to adsorb to natural fibers, and de-sorption occurs through a high ionic strength solution [44]. MO seeds were ground to a fine powder and combined with deionized water (DI) at a ratio of 0.02 (weight of seed/volume of DI). The solution was stirred for 5 minutes and filtered to remove the seed debris. This solution will be referred to as serum. The serum was then coated onto a cotton column at a flowrate of 2 mL/minute. DI water was then pumped through the filter before 30 mL of 600 mM NaCl solution was pumped through to de-sorb MO proteins. The high salinity protein solution was then placed in dialysis tubing (Thermo, catalog number 68035) with a molecular weight cutoff of 3.5 kD. The dialysis bags were placed in 3 L of buffer (1 mM NaCl, 1 mM NaHCO₃, pH 7) with 0.01% (w/v) sodium azide to prevent microbial growth. The buffer was exchanged until conductivity measurements from the final buffer were equal to that of the initial buffer. The protein solution concentration before and after dialysis was analyzed using a fluorometric peptide assay (Pierce). The protein solution post-dialysis was further analyzed by SDS-PAGE using a 4-12% polyacrylamide Novex Tris-Glycine gel. Protein identification utilized liquid chromatography-mass spectrometry (LC-MS), provided by the UT Austin Center for Biomedical Research Support Biological Mass Spectrometry Facility (RRID: SCR_021728). An overview of this procedure is shown in FIG. 13.

Jar tests. Experiments were conducted with 1 mM NaCl and 1 mM NaHCO₃ solution with pH adjusted to 7 prior to the jar test. Controls were performed by adding DI water at an equivalent volume to protein solution additions. The jar test apparatus consisted of six jars. PFOS and PFOA were spiked into jars to reach a target concentration of 100 μg/L. The stirrers were set to 50 rpm for 30 minutes to equilibrate the solution. 1 mL samples were taken from the top inch of each jar and analyzed for PFAS concentrations following equilibration. Jars were spiked with coagulants or DI water (control). Then, the jar test apparatus was set to 150 rpm for 1 minute, 45 rpm for 20 minutes, and no stirring for 30 minutes. Following settling, a sample was taken from the top inch of the jar. Samples without methanol dilution were 1 mL. Samples that were diluted with methanol were 800 μL with 200 μL methanol added. Samples were then analyzed for PFAS concentrations.

PFAS filtration. Experiments were conducted with 1 mM NaCl and 1 mM NaHCO₃ solution with pH adjusted to 7. Fibers (3 grams) of Ceiba pentandra (kapok) or cotton were packed into polypropylene columns (Bio-Rad Econo-Pac, 1.5 cm diameter). 100 mL of Moringa seed serum, as described in the protein purification method, was coated on each column at a flowrate of 2 mL/minute to adsorb the cationic proteins. Each column was then rinsed with 50 mL DI water. Columns were equilibrated with 100 mL of 1 mM NaCl and 1 mM NaHCO₃buffer prior to PFAS filtration. The influent buffer was then spiked with PFOA and PFOS to reach a concentration of 30 μg/L. Influent 1 mL samples of the filter effluent were taken at designated bed volumes. Packed fiber control columns were run without coating MO proteins to evaluate system losses.

PFAS quantification. PFAS concentrations were analyzed via liquid chromatography tandem mass spectrometry (LC/MS-MS) on a Shimadzu 8060 triple quadrupole mass spectrometer. The analytical column used was an Agilent ZORBAX Eclipse Plus C₁₈ narrow bore column with 5 μm particle size (959746-902). A flow rate of 0.7 mL/minute was used with a column temperature of 40° C. and injection volume of 1 L. The solvents used were 2 mM ammonium acetate in water (A) and acetonitrile (B). The solvent gradient is as follows: 0 min (32% B), 1.30 min (+21.82%/min B), 3.50 min (−480%/min B), 3.60 min (32% B), complete at 5.50 min. The triple quadrupole was operated in electrospray ionization (ESI) negative mode with a needle voltage of −3 kV. The nebulizer flow was 2 L/min with gas flow 10 L/min. The interface temperature was 300° C. with desolvation temperature 526° C. and drying gas flow at 10 L/min. Q1 and Q3 were set to unit resolution for PFOA and PFOS (collision energy 11 and 39, respectively). A calibration curve from 1-100 ppb of PFOA and PFOS in methanol was run for each sample set.

¹⁹F NMR. ¹⁹F NMR measurements were taken on a Bruker AVANCE III 500 NMR. 3,000 scans were run for each sample with a 1 second relaxation delay. TFMAA was added to each sample as an internal standard. 90% H₂O and 10% D20 were used for instrument lock and calibration. PFAS concentrations remained constant at 50 mg/L. 450 L of sample was used for each run. ¹⁹F NMR spectra were obtained with a spectral width 113636.36 Hz and spectral frequency 470.57 MHz.

Spectrum were analyzed via MestreNova software for phase correction and baseline correction. Peak picking was completed automatically by the software. When the software did not recognize a peak, a manual threshold and peak-by-peak picking was used to ensure every peak intensity was recorded. Intensities were normalized by TFMAA peak area at approximately −64.9 ppm. NMR data is included in the Supporting Information. The NMR peak height ratio, B, can be used to determine the relative ranking of binding affinities between protein-ligand complexes [45]. B was calculated using Equation (1)

$$B = 1 - \frac{{l}_{b}}{{l}_{h}} \qquad ( 1 )$$

Where l_{b} is the sum of ligand NMR heights in the presence of protein and lₕ is the sum of free ligand NMR heights.

Molecular docking and molecular dynamics. Molecular docking was performed using AutoDock Vina [46]. The proteins (PDB: 5DOM, 6S3F) were prepared in AutoDock Tools to remove water molecules, add hydrogen atoms (polar only), and add Kollman charge. The 3D structure files for PFOS (CID: 3736298) and PFOA (CID: 4986139) were downloaded from PubChem in the deprotonated form and converted to PDB files using OpenBabel [48]. The binding site boundaries were determined by the Grid Box feature in AutoDock Tools. Nine protein-ligand configurations were generated using AutoDock Vina for MO2.1, MoCBP, PFOS, and PFOA, resulting in 36 protein-ligand structures. AutoDock Vina results were visualized in PyMOL [49].

### Results and Discussion

MO protein purification and coagulation. MO protein was purified and identified through mass spectrometry. The results summarized in Table 3 indicate a high concentration of MoCBP. MoCBP exists as a 14 kDa heterodimer that has been observed in SDS-PAGE analysis at 18.0 kDa [50], which likely composes band 1 in FIG. 13. Band 2 has a much lower concentration and migrated to ˜26 kDa. Previous work has identified MO2.1 tetramers at 26 kDa [51], which indicates a lower concentration of MO2.1 in the sample. Band 3 may consist of MoCBP tetramers which migrated to ˜54 kDa.

TABLE 3
Liquid chromatography-mass spectrometry results for purified MO proteins.

| | | | | Quantitative Value | | |
|---|---|---|---|---|---|---|
| | Accession | Molecular | | (Normalized Total Spectra) | | |
| Identified Proteins | Number | Weight | | Band 1 | Band 2 | Band 3 |
| 2S albumin | W5S2D2 | 19 | kDa | 82.077 | 25.402 | 8.0459 |
| OS = Moringa oleifera | | | | | | |
| OX = 3735 PE = 1 SV = 1 | | | | | | |
| 2S albumin | W5S3M0 | 19 | kDa | 32.831 | 12.701 | 0 |
| OS = Moringa oleifera | | | | | | |
| OX = 3735 PE = 2 SV = I | | | | | | |
| Albumin | Cont_P02769 | 69 | kDa | 32.01 | 52.074 | 51.293 |
| OS = Bos taurus OX = 9913 | | | | | | |
| GN = ALB PE = 1 SV = 4 | | | | | | |
| 2S albumin | W5S743 | 18 | kDa | 36.114 | 10.161 | 4.023 |
| OS = Moringa oleifera | | | | | | |
| OX = 3735 PE = 2 SV = 1 | | | | | | |
| CBP3 | A0A3G61GT2 | 19 | kDa | 31.189 | 7.6206 | 0 |
| OS = Moringa oleifera | | | | | | |
| OX = 3735 PE = 3 SV = 1 | | | | | | |
| Chitin-binding | C0HKCS | 12 | kDa | 56.633 | 0 | 0 |
| protein 2 (Fragment) | | | | | | |
| OS = Moringa oleifera | | | | | | |
| OX = 3735 PE = 1 SV = 1 | | | | | | |
| CBP3 | A0A3G61ME9 | 19 | kDa | 9.8493 | 2.5402 | 3.0172 |
| OS = Moringa oleifera | | | | | | |
| OX = 3735 PE = 3 SV = 1 | | | | | | |
| CBP3 | A0A3G61ME9 | 19 | kDa | 9.8493 | 2.5402 | 3.0172 |
| OS = Moringa oleifera | | | | | | |
| OX = 3735 PE = 3 SV = 1 | | | | | | |
| 2S albumin | W5S2K0 | 19 | kDa | 9.0285 | 0 | 0 |
| OS = Moringa oleifera | | | | | | |
| OX = 3735 PE = 2 SV = 1 | | | | | | |
| 2.1 protein (Fragment) | Q93YG0 | 7 | kDa | 7.387 | 3.8103 | 0 |
| OS = Moringa oleifera OX = | | | | | | |
| 3735 GN = 2.1 PE = 2 SV = 1 | | | | | | |
| Protein TIC 214 | A0A4Y5PS30 | 222 | kDa | 0.82077 | 6.3505 | 5.0287 |
| OS = Moringa oleifera OX = | | | | | | |
| 3735 GN = ycfl PE = 3 SV = 1 | | | | | | |
| Protein Ycf2 | A0A482EBE0 | 269 | kDa | 1.6415 | 2.5402 | 9.0516 |
| OS = Moringa oleifera OX = | | | | | | |
| 3735 GN = ycf2 PE = 3 SV = 1 | | | | | | |
| Intersect in 1 | Cont_E1BKY4 | 195 | kDa | 1.6415 | 2.5402 | 1.0057 |
| OS = Bos taurus OX = 9913 | | | | | | |
| GN = ITSN1 PE = 4 SV = 3 | | | | | | |
| Trypsin OS = Sus scrofa | Cont_P00761 | 24 | kDa | 0.82077 | 11.431 | 9.0516 |
| OX = 9823 PE = 1 SV = 1 | | | | | | |
| Trehalose-6- | A0A345K452 | 97 | kDa | 0.82077 | 3.8103 | 4.023 |
| phosphate synthase | | | | | | |
| OS = Moringa oleifera | | | | | | |
| OX = 3735 PE = 2 SV = 1 | | | | | | |
| Complement C3 | Cont_Q2UVX4 | 187 | kDa | 0 | 0 | 3.0172 |
| OS = Bos taurus OX = 9913 | | | | | | |
| GN = C3 PE = 1 SV = 2 | | | | | | |
| Coagulation factor V | Cont_Q28107 | 249 | kDa | 0 | 0 | 4.023 |
| OS = Bos taurus OX = 9913 | | | | | | |
| GN = F5 PE = 1 SV = 1 | | | | | | |
| Collagen alpha-1 (III) chain | Cont_P04258 | 94 | kDa | 3.2831 | 1.2701 | 4.023 |
| OS = Bos taurus OX = 9913 | | | | | | |
| GN = COL3A1 PE = 1 SV = 1 | | | | | | |
| Alpha-2-macroglobulin | Cont_Q7S1HI | 168 | kDa | 3.2831 | 3.8103 | 1.0057 |
| OS = Bos taurus OX = 9913 | | | | | | |
| GN = A2M PE = 1 SV = 2 | | | | | | |
| Putative LOV domain- | A0A126WWV6 | 68 | kDa | 2.4623 | 5.0804 | 5.0287 |
| containing protein | | | | | | |
| OS = Moringa oleifera | | | | | | |
| OX = 373S PE = 2 SV = 1 | | | | | | |
| Complement component C7 | Cont_Q29RQ1 | 93 | kDa | 1.6415 | 3.8103 | 1.0057 |
| OS = Bos taurus OX = 9913 | | | | | | |
| GN = C7 PE = 2 SV = 1 | | | | | | |
| Complement C4 (Fragments) | Cont_P01030 | 102 | kDa | 5.7454 | 1.2701 | 2.0115 |
| OS = Bos taurus OX = 9913 | | | | | | |
| GN = C4 PE = 1 SV = 2 | | | | | | |

The addition of MO protein in coagulation experiments was shown to remove approximately 65% of PFOA and 75% of PFOS without methanol dilution (FIG. 14). Two additional proteins were investigated, bovine serum albumin (BSA) and lysozyme. At neutral pH, BSA has an overall negative charge and lysozyme has an overall positive charge [52, 53].

Both proteins provide less than 20% removal of the PFAS investigated, surprisingly indicating a unique interaction between PFAS and MO protein that is not fully based on charge.

However, when samples were diluted 80/20 water/MeOH, “removal” significantly decreased. Without wishing to be bound by theory, this is consistent with the presence of the PFAS-MO complex in the sample. The MO proteins prevent PFAS from being detected in the LC-MS. When samples are diluted with MeOH, the PFAS-MO complex dissociates, and the LC-MS is able to detect PFAS. These results suggest that the PFAS are not settling during the sedimentation phase of the jar tests.

Post-coagulation water analysis. The implementation of bio-coagulants has been limited due to the addition of organic matter to the water. In this work, the addition of MO proteins results in a final DOC of 1.1 mg/L. This is similar to values shown in literature that utilize ion exchange for protein purification [54]. There is an inherent amount of organic matter in MO proteins that cannot be further purified or removed.

The different coagulants studied in this work did not have a significant impact on pH. pH values remained between 6.99 and 7.49 following sedimentation. The specific pH changes for each coagulant are shown in Table 4.

TABLE 4
pH changes for jar test experiments.

| Jar test additions | Change in pH |
|---|---|
| MO protein | 0.1 |
| MO protein + FeCl₃ | −0.24 |
| FeCl₃ | −0.27 |
| Lysozyme | −0.34 |
| BSA | −0.4 |
| Control - DI water | −0.35 |

¹⁹F NMR. NMR can be used to study protein-ligand interactions by examining changes in peak height, peak width, and chemical shifts [45, 55]. A decrease in peak height indicates the formation of a protein-ligand complex [45, 56]. Previous literature has used ¹⁹F NMR to look at PFAS binding to albumin proteins [55, 57]. In this work, PFAS (ligand) concentrations remain constant while MO protein concentrations were varied.

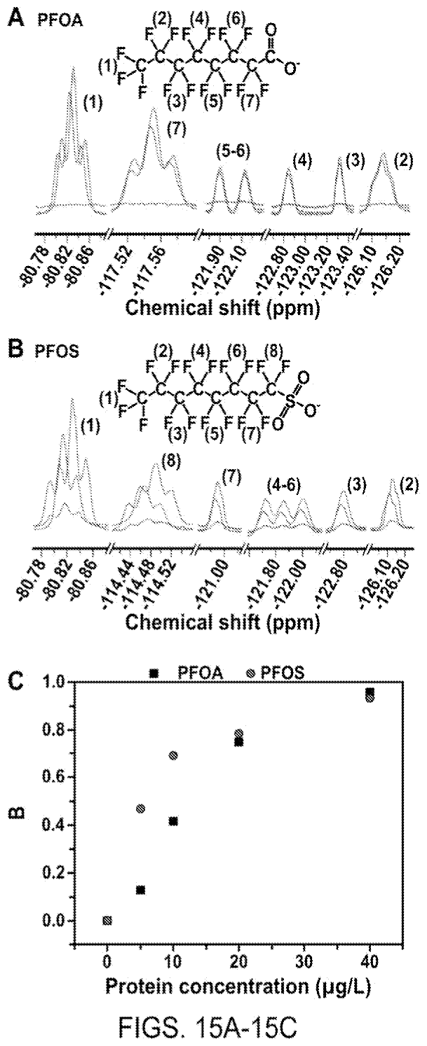

FIGS. 15A-15B show decreasing peak heights for three MO protein concentrations at peaks corresponding to the various-CF bonds. The peak intensity, width, and area for all NMR experiments is shown in Tables 5-14. The changes in chemical shifts and peak height indicate the formation of a protein-ligand complex. The NMR peak height ratio, B, shown in FIG. 15C is proportional to the degree of binding. This indicates that MO-PFOS has stronger affinity than MO-PFOA at lower protein concentrations. However, when protein concentrations increase, the binding affinity is similar for PFOA and PFOS.

TABLE 5
¹⁹F NMR results for PFOS at 0 μg/L MO protein concentration.

| PFOA, | | | | | |
|---|---|---|---|---|---|
| 40 μg/L | | | | | Normalized |
| protein | ppm | Intensity | Width | Area | intensity |
| 1 | −65.09 | 348.2 | 6.94 | 4376.19 | 1 |
| 2 | −80.81 | 182.4 | 5.24 | 1730.38 | 0.523836875 |
| 3 | −80.83 | 353.7 | 10.4 | 6667.48 | 1.01579552 |
| 4 | −80.85 | 196.5 | 6.07 | 2160.26 | 0.564330844 |
| 5 | −114.46 | 116.5 | 13.4 | 2827.54 | 0.334577829 |
| 6 | −114.49 | 181.6 | 16.47 | 5420.92 | 0.521539345 |
| 7 | −120.95 | 133.4 | 35.09 | 8482.74 | 0.383113153 |
| 8 | −121.72 | 95.8 | 49.42 | 8574.31 | 0.275129236 |
| 9 | −121.86 | 90.2 | 45.49 | 7437.39 | 0.259046525 |
| 10 | −122.01 | 95.3 | 52.02 | 8985.92 | 0.27369328 |
| 11 | −122.79 | 106.1 | 40.75 | 7833.5 | 0.304709937 |
| 12 | −126.13 | 142.8 | 33.35 | 8626.92 | 0.410109133 |

TABLE 6
¹⁹F NMR results for PFOS at 5 μg/L MO protein concentration.

| PFOA, | | | | | |
|---|---|---|---|---|---|
| 40 μg/L | | | | | Normalized |
| protein | ppm | Intensity | Width | Area | intensity |
| 1 | −65.04 | 552.4 | 7.8 | 7809.02 | 1 |
| 2 | −80.8 | 149.6 | 6.32 | 1712.73 | 0.270818248 |
| 3 | −80.82 | 288.5 | 13 | 6797.1 | 0.522266474 |
| 4 | −80.84 | 150.9 | 6.59 | 1802.41 | 0.273171615 |
| 5 | −114.44 | 103.1 | 13.18 | 2460.29 | 0.186640116 |
| 6 | −114.47 | 151.5 | 28.56 | 7839.3 | 0.274257784 |
| 7 | −120.94 | 118.7 | 38.96 | 8377.92 | 0.214880521 |
| 8 | −121.7 | 83.1 | 43.35 | 6522.84 | 0.150434468 |
| 9 | −121.84 | 78.1 | 47.63 | 6742.75 | 0.141383056 |
| 10 | −121.99 | 84.5 | 49.42 | 7569.44 | 0.152968863 |
| 11 | −122.79 | 95.8 | 45.08 | 7825.15 | 0.173425054 |
| 12 | −126.11 | 124.3 | 35.49 | 7993.36 | 0.225018103 |

TABLE 7
¹⁹F NMR results for PFOS at 10 μg/L MO protein concentration.

| PFOA, | | | | | |
|---|---|---|---|---|---|
| 40 μg/L | | | | | Normalized |
| protein | ppm | Intensity | Width | Area | intensity |
| 1 | −65.03 | 728.1 | 4.94 | 6522.72 | 1 |
| 2 | −80.79 | 131.3 | 6.18 | 1471.17 | 0.180332372 |
| 3 | −80.81 | 267.2 | 7.97 | 3858.5 | 0.366982557 |
| 4 | −80.83 | 146.7 | 7.03 | 1868.26 | 0.201483313 |
| 5 | −114.44 | 66.4 | 9.96 | 1198.19 | 0.091196264 |
| 6 | −114.47 | 116.1 | 14.19 | 2985.35 | 0.159456119 |
| 7 | −120.93 | 79.4 | 2.6 | 374.34 | 0.109050955 |
| 8 | −121.71 | 43.3 | 1.73 | 136.12 | 0.059469853 |
| 9 | −121.85 | 39.5 | 3.47 | 248.48 | 0.05425079 |
| 10 | −121.99 | 48.6 | 7.8 | 687.29 | 0.066749073 |
| 11 | −122.78 | 63.2 | 5.2 | 595.7 | 0.086801264 |
| 12 | −126.11 | 93.3 | 10.4 | 1758.75 | 0.128141739 |

TABLE 8
¹⁹F NMR results for PFOS at 20 μg/L MO protein concentration.

| PFOA, | | | | | |
|---|---|---|---|---|---|
| 40 μg/L | | | | | Normalized |
| protein | ppm | Intensity | Width | Area | intensity |
| 1 | −65.01 | 649.6 | 5.5 | 6471.27 | 1 |
| 2 | −80.79 | 77.8 | 5.83 | 1244.36 | 0.11976601 |
| 3 | −80.81 | 158.5 | 8.67 | 2489.84 | 0.243996305 |
| 4 | −114.44 | 55.8 | 11.88 | 1201.05 | 0.085899015 |
| 5 | −114.47 | 87.5 | 9.54 | 1511.46 | 0.134698276 |
| 6 | −120.93 | 64.5 | 2.6 | 303.75 | 0.099291872 |
| 7 | −121.7 | 38.3 | 2.6 | 180.5 | 0.05895936 |
| 8 | −121.84 | 37.7 | 2.6 | 177.74 | 0.058035714 |
| 9 | −121.98 | 42.4 | 4.33 | 333.37 | 0.065270936 |
| 10 | −122.78 | 52.3 | 3.47 | 328.63 | 0.080511084 |
| 11 | −126.12 | 68.7 | 6.07 | 755.19 | 0.105757389 |

TABLE 9
¹⁹F NMR results for PFOS at 40 μg/L MO protein concentration.

| PFOA, | | | | | |
|---|---|---|---|---|---|
| 40 μg/L | | | | | Normalized |
| protein | ppm | Intensity | Width | Area | intensity |
| 1 | −65 | 691.1 | 6.94 | 8684.86 | 1 |
| 2 | −80.8 | 30.9 | 6.69 | 373.83 | 0.04471133 |
| 3 | −80.82 | 65.7 | 8 | 952.04 | 0.095065837 |
| 4 | −114.48 | 20.6 | 10.72 | 399.64 | 0.029807553 |
| 5 | −120.94 | 21.6 | 31.21 | 1218.7 | 0.031254522 |
| 6 | −121.73 | 13.2 | 33.13 | 794.35 | 0.019099986 |
| 7 | −121.86 | 16 | 64.35 | 1860.45 | 0.023151498 |
| 8 | −121.99 | 20.3 | 29.67 | 1090.99 | 0.029373463 |
| 9 | −122.8 | 19 | 52.89 | 1816.69 | 0.027492403 |
| 10 | −126.11 | 24.4 | 25.14 | 1111.37 | 0.035306034 |

TABLE 10
¹⁹F NMR results for PFOA at 0 μg/L MO protein concentration.

| PFOA, | | | | | |
|---|---|---|---|---|---|
| 40 μg/L | | | | | Normalized |
| protein | ppm | Intensity | Width | Area | intensity |
| 1 | −65.1 | 496.6 | 6.94 | 6240.4 | 1 |
| 2 | −80.81 | 159.5 | 7.45 | 2152.09 | 0.321184052 |
| 3 | −80.83 | 307.7 | 10.4 | 5800.47 | 0.619613371 |
| 4 | −80.85 | 158.9 | 5.43 | 1562.08 | 0.319975836 |
| 5 | −117.53 | 119.1 | 9.82 | 2119.45 | 0.23983085 |
| 6 | −117.55 | 224.8 | 13 | 5295.79 | 0.452678212 |
| 7 | −117.57 | 127.4 | 7.48 | 1726.4 | 0.256544503 |
| 8 | −121.9 | 103.2 | 43.35 | 8104.77 | 0.207813129 |
| 9 | −122.13 | 96.7 | 44.22 | 7747.41 | 0.194724124 |
| 10 | −122.84 | 100.7 | 40.75 | 7431.35 | 0.202778896 |
| 11 | −123.32 | 126.9 | 36.41 | 8371.4 | 0.255537656 |
| 12 | −126.14 | 133.2 | 29.94 | 7227.73 | 0.268223923 |

TABLE 11
¹⁹F NMR results for PFOA at 5 μg/L MO protein concentration.

| PFOA, | | | | | |
|---|---|---|---|---|---|
| 40 μg/L | | | | | Normalized |
| protein | ppm | Intensity | Width | Area | intensity |
| 1 | −65.07 | 342.8 | 7.93 | 4927.25 | 1 |
| 2 | −80.81 | 137.5 | 16.33 | 4068.05 | 0.401108518 |
| 3 | −80.83 | 180.4 | 11.1 | 3629.64 | 0.526254376 |
| 4 | −117.53 | 105.9 | 8.67 | 1664.03 | 0.308926488 |
| 5 | −117.54 | 149.6 | 6.94 | 1879.33 | 0.436406068 |
| 6 | −121.89 | 76.8 | 4.33 | 603.24 | 0.22403734 |
| 7 | −122.12 | 74.1 | 6.07 | 814.94 | 0.216161027 |
| 8 | −122.84 | 77.1 | 1.73 | 242.36 | 0.224912485 |
| 9 | −123.31 | 97.6 | 4.33 | 766.82 | 0.284714119 |
| 10 | −126.12 | 100 | 8.67 | 1571.47 | 0.291715286 |

TABLE 12
¹⁹F NMR results for PFOA at 10 μg/L MO protein concentration.

| PFOA, | | | | | |
|---|---|---|---|---|---|
| 40 μg/L | | | | | Normalized |
| protein | ppm | Intensity | Width | Area | intensity |
| 1 | −65.06 | 655.5 | 5.87 | 6967.65 | 1 |
| 2 | −80.8 | 126.4 | 6.52 | 1494.37 | 0.192829901 |
| 3 | −80.82 | 265.9 | 8.11 | 3908.55 | 0.405644546 |
| 4 | −80.84 | 143.1 | 8.29 | 2148.7 | 0.218306636 |
| 5 | −117.53 | 92.8 | 10.99 | 1848.41 | 0.14157132 |
| 6 | −117.55 | 192.8 | 11.46 | 4004.17 | 0.294126621 |
| 7 | −121.9 | 83 | 5.2 | 782.54 | 0.1266209 |
| 8 | −122.12 | 77.3 | 3.47 | 485.73 | 0.117925248 |
| 9 | −122.84 | 81.4 | 7.8 | 1150.48 | 0.124180015 |
| 10 | −123.32 | 103.9 | 2.6 | 489.58 | 0.158504958 |
| 11 | −126.14 | 110.8 | 8.67 | 1740.44 | 0.169031274 |

TABLE 13
¹⁹F NMR results for PFOA at 20 μg/L MO protein concentration.

| PFOA, | | | | | |
|---|---|---|---|---|---|
| 40 μg/L | | | | | Normalized |
| protein | ppm | Intensity | Width | Area | intensity |
| 1 | −65.03 | 421 | 5.93 | 4520.27 | 1 |
| 2 | −80.83 | 78.6 | 9.54 | 1358.04 | 0.186698337 |
| 3 | −117.56 | 59.1 | 6.07 | 649.37 | 0.140380048 |
| 4 | −121.9 | 42.7 | 2.6 | 201.06 | 0.101425178 |
| 5 | −122.13 | 38 | 2.6 | 178.85 | 0.090261283 |
| 6 | −122.84 | 40.7 | 3.47 | 255.45 | 0.096674584 |
| 7 | −123.32 | 46.7 | 3.47 | 293.72 | 0.110926366 |
| 8 | −126.14 | 46.1 | 5.2 | 434.31 | 0.109501188 |

TABLE 14
¹⁹F NMR results for PFOA at 40 μg/L MO protein concentration.

| PFOA, | | | | | |
|---|---|---|---|---|---|
| 40 μg/L | | | | | Normalized |
| protein | ppm | Intensity | Width | Area | intensity |
| 1 | −65.01 | 490.5 | 7.42 | 6591.85 | 1 |
| 2 | −80.86 | 16.2 | 66.62 | 1955.14 | 0.033027523 |
| 3 | −117.55 | 10.4 | 73.56 | 1385.25 | 0.021202854 |
| 4 | −122.1 | 10.9 | 120.51 | 2390.04 | 0.022222222 |
| 5 | −122.85 | 9.3 | 107.51 | 1805.93 | 0.018960245 |
| 6 | −123.29 | 10 | 72.83 | 1315.77 | 0.02038736 |
| 7 | −126.13 | 12 | 109.24 | 2366.81 | 0.024464832 |

Molecular docking. Nine protein-ligand configurations were generated by AutoDock Vina. For MoCBP-PFOS, eight of the nine configurations were slight variations in the same binding pocket.

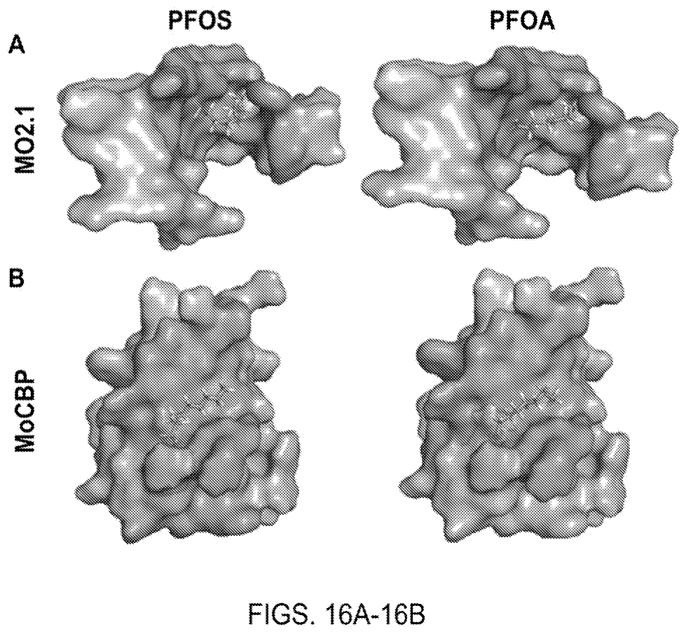

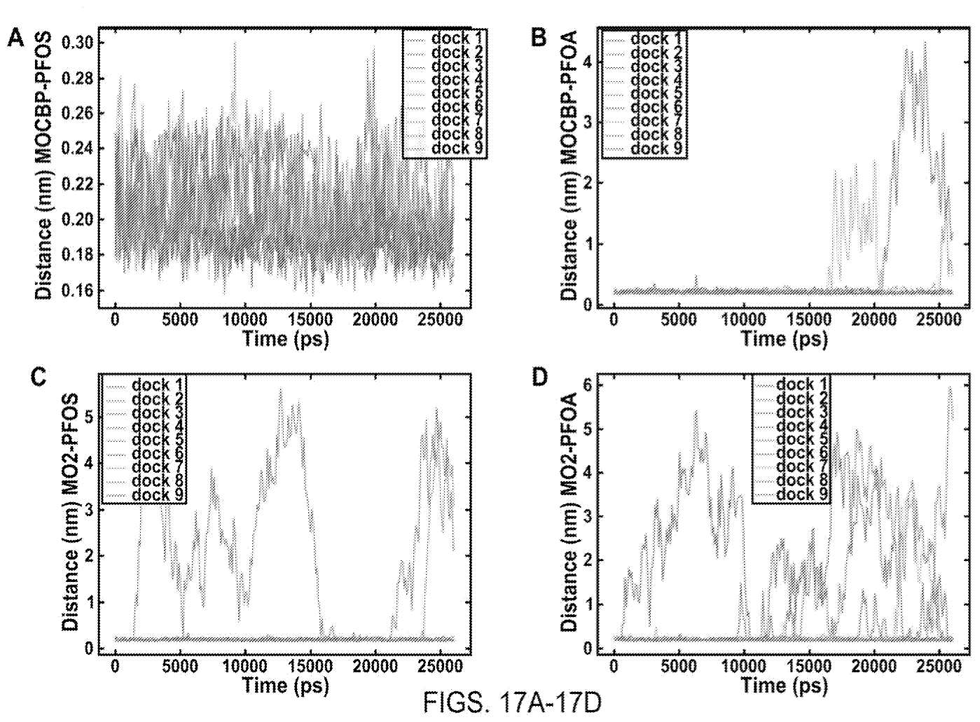

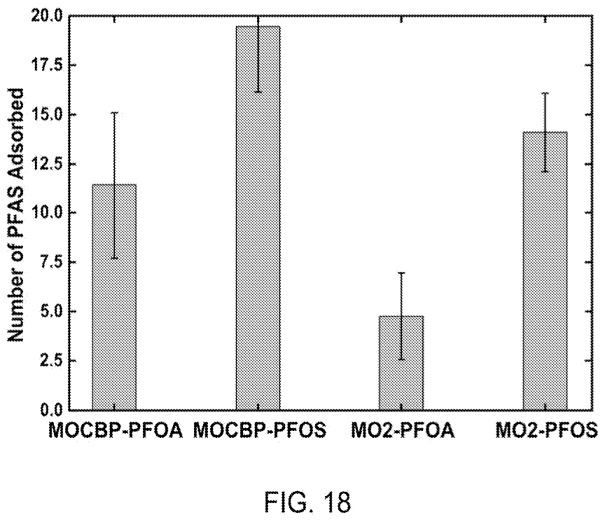

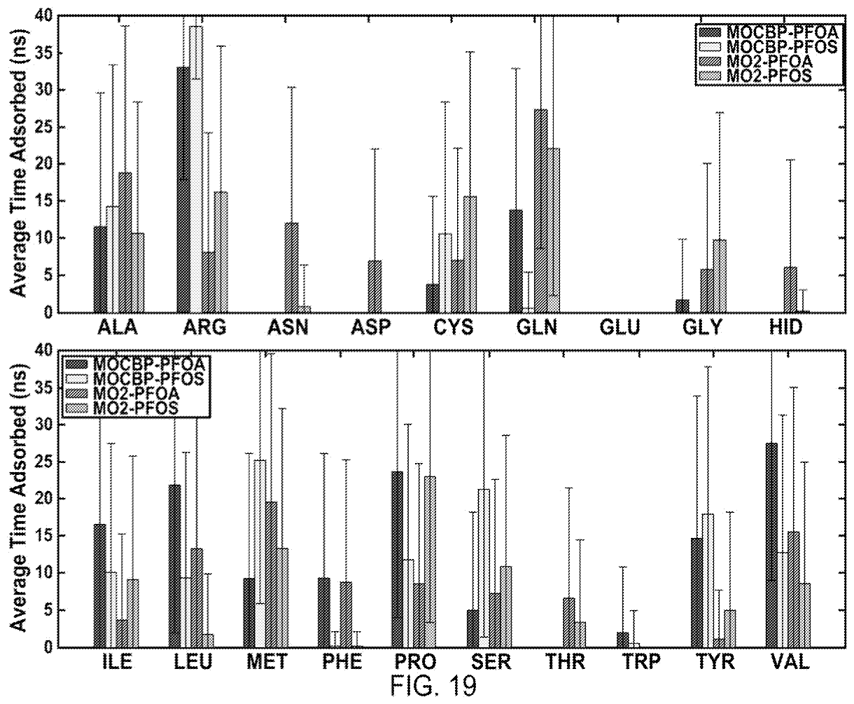

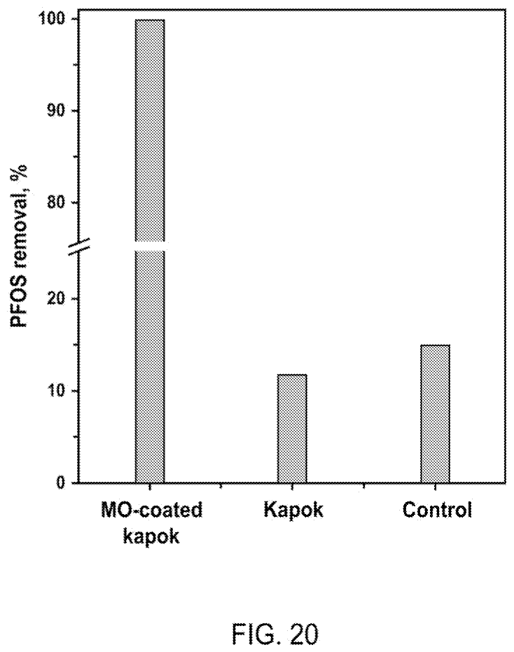

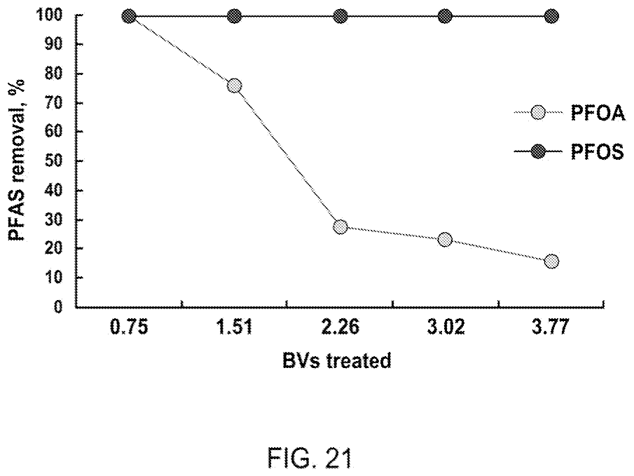

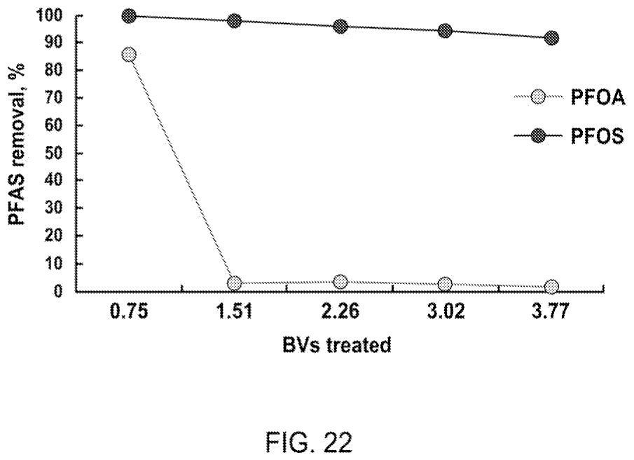

The results showing the highest affinity protein-ligand docking are shown in FIGS. 16A-16B. MoCBP and MO2.1 were each docked with PFOA and PFOS individually. The polar and non-polar amino acids of the protein that interact with the PFAS are shown. The highest affinity docking is substantially in the same regions for each protein-ligand combination.

### EXAMPLE 2 REFERENCES

[1] B. C. Crone et al., “Occurrence of per- and polyfluoroalkyl substances (PFAS) in source water and their treatment in drinking water,” Critical reviews in environmental science and technology, vol. 49, no. 24, pp. 2359-2396, 2019.
[2] E. Houtz, M. Wang, and J.-S. Park, “Identification and Fate of Aqueous Film Forming Foam Derived Per- and Polyfluoroalkyl Substances in a Wastewater Treatment Plant,” Environmental Science & Technology, vol. 52, no. 22, pp. 13212-13221, 2018 Nov. 20, 2018, doi: 10.1021/acs.est.8b04028.
[3] M. Kotthoff, J. Müller, H. Jürling, M. Schlummer, and D. Fiedler, “Perfluoroalkyl and polyfluoroalkyl substances in consumer products,” Environmental Science and Pollution Research, vol. 22, no. 19, pp. 14546-14559, 2015 Oct. 1, 2015, doi: 10.1007/s11356-015-4202-7.
[4] L. A. Schaider et al., “Fluorinated compounds in US fast food packaging,” Environmental science & technology letters, vol. 4, no. 3, pp. 105-111, 2017.
[5] X. C. Hu et al., “Detection of Poly- and Perfluoroalkyl Substances (PFASs) in U.S. Drinking Water Linked to Industrial Sites, Military Fire Training Areas, and Wastewater Treatment Plants,” Environmental Science & Technology Letters, vol. 3, no. 10, pp. 344-350, 2016 Oct. 11 2016, doi: 10.1021/acs.estlett.6b00260.
[6] Y. Li et al., “Perfluoroalkyl acids in drinking water of China in 2017: Distribution characteristics, influencing factors and potential risks,” Environment International, vol. 123, pp. 87-95, 2019 Feb. 1, 2019, doi: doi.org/10.1016/j.envint.2018.11.036.
[7] J. R. Lang, B. M. Allred, J. A. Field, J. W. Levis, and M. A. Barlaz, “National Estimate of Per- and Polyfluoroalkyl Substance (PFAS) Release to U.S. Municipal Landfill Leachate,” Environmental Science & Technology, vol. 51, no. 4, pp. 2197-2205, 2017 Feb. 21 2017, doi: 10.1021/acs.est.6b05005.
[8] Z. Wei, T. Xu, and D. Zhao, “Treatment of per- and polyfluoroalkyl substances in landfill leachate: status, chemistry and prospects,” Environmental Science: Water Research & Technology, vol. 5, no. 11, pp. 1814-1835, 2019.
[9] I. T. Cousins et al., “The high persistence of PFAS is sufficient for their management as a chemical class,” Environmental Science: Processes & Impacts, vol. 22, no. 12, pp. 2307-2312, 2020.
[10] C. Zhang, A. C. McElroy, H. K. Liberatore, N. L. M. Alexander, and D. R. U. Knappe, “Stability of Per- and Polyfluoroalkyl Substances in Solvents Relevant to Environmental and Toxicological Analysis,” Environmental Science & Technology, vol. 56, no. 10, pp. 6103-6112, 2022 May 17 2022, doi: 10.1021/acs.est. 1c03979
[11] K. H. Kucharzyk, R. Darlington, M. Benotti, R. Deeb, and E. Hawley, “Novel treatment technologies for PFAS compounds: A critical review,” Journal of Environmental Management, vol. 204, pp. 757-764, 2017 Dec. 15, 2017, doi: doi.org/10.1016/j.jenvman.2017.08.016.
[12] G. M. Sinclair, S. M. Long, and O. A. H. Jones, “What are the effects of PFAS exposure at environmentally relevant concentrations?,” Chemosphere, vol. 258, p. 127340, 2020 Nov. 1, 2020, doi: doi.org/10.1016/j.chemosphere.2020.127340.
[13] X. Xiao, B. A. Ulrich, B. Chen, and C. P. Higgins, “Sorption of Poly- and Perfluoroalkyl Substances (PFASs) Relevant to Aqueous Film-Forming Foam (AFFF)-Impacted Groundwater by Biochars and Activated Carbon,” Environmental Science & Technology, vol. 51, no. 11, pp. 6342-6351, 2017 Jun. 6 2017, doi: 10.1021/acs.est. 7b00970.
[14] C. M. Butt, U. Berger, R. Bossi, and G. T. Tomy, “Levels and trends of poly- and perfluorinated compounds in the arctic environment,” Science of The Total Environment, vol. 408, no. 15, pp. 2936-2965, 2010 Jul. 1, 2010, doi: doi.org/10.1016/j.scitotenv.2010.03.015.
[16] D. Szabo et al., “A baseline study of per- and polyfluoroalkyl substances (PFASs) in waterfowl from a remote Australian environment,” Science of The Total Environment, vol. 812, p. 152528, 2022 Mar. 15, 2022, doi: doi.org/10.1016/j.scitotenv.2021.152528.
[16] M. K. So et al., “Health risks in infants associated with exposure to perfluorinated compounds in human breast milk from Zhoushan, China,” Environmental science & technology, vol. 40, no. 9, pp. 2924-2929, 2006.
[17] K. Kannan et al., “Perfluorooctanesulfonate and Related Fluorochemicals in Human Blood from Several Countries,” Environmental Science & Technology, vol. 38, no. 17, pp. 4489-4495, 2004 Sep. 1 2004, doi: 10.1021/es0493446.
[18] J. P. Giesy and K. Kannan, “Global Distribution of Perfluorooctane Sulfonate in Wildlife,” Environmental Science & Technology, vol. 35, no. 7, pp. 1339-1342, 2001 Apr. 1 2001, doi: 10.1021/es001834k.
[19] CDC. “Per- and Polyfluorinated Substances (PFAS) Factsheet.” Centers for Disease Control and Prevention. www.cdc.gov/biomonitoring/PFAS_FactSheet.html (accessed Aug. 30, 2022).
[20] A. O. De Silva et al., “PFAS Exposure Pathways for Humans and Wildlife: A Synthesis of Current Knowledge and Key Gaps in Understanding,” Environmental Toxicology and Chemistry, vol. 40, no. 3, pp. 631-657, 2021, doi: doi.org/10.1002/etc.4935.
[21] V. Barry, A. Winquist, and K. Steenland, “Perfluorooctanoic Acid (PFOA) Exposures and Incident Cancers among Adults Living Near a Chemical Plant,” Environmental Health Perspectives, vol. 121, no. 11-12, pp. 1313-1318, 2013, doi: doi: 10.1289/ehp.1306615.
[22] G. Du et al., “Perfluorooctane sulfonate (PFOS) affects hormone receptor activity, steroidogenesis, and expression of endocrine-related genes in vitro and in vivo,” Environmental Toxicology and Chemistry, vol. 32, no. 2, pp. 353-360, 2013, doi: doi.org/10.1002/etc.2034.
[23] A. A. Jensen and H. Leffers, “Emerging endocrine disrupters: perfluoroalkylated substances,” International Journal of Andrology, vol. 31, no. 2, pp. 161-169, 2008, doi: doi.org/10.1111/j.1365-2605.2008.00870.x.
[24] M. Houde et al., “Polyfluoroalkyl Compounds in Free-Ranging Bottlenose Dolphins (Tursiops truncatus) from the Gulf of Mexico and the Atlantic Ocean,” Environmental Science & Technology, vol. 39, no. 17, pp. 6591-6598, 2005 Sep. 1 2005, doi: 10.1021/es0506556.
[25] M. Forsthuber et al., “Albumin is the major carrier protein for PFOS, PFOA, PFHxS, PFNA and PFDA in human plasma,” Environment International, vol. 137, p. 105324, 2020 Apr. 1, 2020, doi: doi.org/10.1016/j.envint.2019.105324.
[26] C. A. Ng and K. Hungerbühler, “Bioaccumulation of Perfluorinated Alkyl Acids: Observations and Models,” Environmental Science & Technology, vol. 48, no. 9, pp. 4637-4648, 2014 May 6 2014, doi: 10.1021/es404008g.
[27] J. P. V. Heuvel, B. I. Kuslikis, M. J. Van Rafelghem, and R. E. Peterson, “Tissue distribution, metabolism, and elimination of perfluorooctanoic acid in male and female rats,” Journal of Biochemical Toxicology, vol. 6, no. 2, pp. 83-92, 1991, doi: doi.org/10.1002/jbt.2570060202.
[28] L. Ahrens, U. Siebert, and R. Ebinghaus, “Total body burden and tissue distribution of polyfluorinated compounds in harbor seals (Phoca vitulina) from the German Bight,” Marine Pollution Bulletin, vol. 58, no. 4, pp. 520-525, 2009 Apr. 1, 2009, doi: doi.org/10.1016/j.marpolbul.2008.11.030.
[29] N. J. M. Fitzgerald et al., “Partitioning and Accumulation of Perfluoroalkyl Substances in Model Lipid Bilayers and Bacteria,” Environmental Science & Technology, vol. 52, no. 18, pp. 10433-10440, 2018 Sep. 18 2018, doi: 10.1021/acs.est.8b02912.
[30] S. Nouhi et al., “Interactions of perfluoroalkyl substances with a phospholipid bilayer studied by neutron reflectometry,” Journal of Colloid and Interface Science, vol. 511, pp. 474-481, 2018 Feb. 1, 2018, doi: doi.org/10.1016/j.jcis.2017.09.102.
[31] U. S. EPA. “Drinking Water Health Advisories for PFOA and PFOS.” www.epa.gov/ground-water-and-drinking-water/drinking-water-health-advisories-pfoa-and-pfos (accessed May 12, 2022).
[32] M. P. Krafft and J. G. Riess, “Per- and polyfluorinated substances (PFASs): Environmental challenges,” Current Opinion in Colloid & Interface Science, vol. 20, no. 3, pp. 192-212, 2015 Jun. 1, 2015, doi: doi.org/10.1016/j.cocis.2015.07.004.
[33] V. Boiteux et al., “Concentrations and patterns of perfluoroalkyl and polyfluoroalkyl substances in a river and three drinking water treatment plants near and far from a major production source,” Science of The Total Environment, vol. 583, pp. 393-400, 2017 Apr. 1, 2017, doi: doi.org/10.1016/j.scitotenv.2017.01.079.
[34] K. Y. Kim, O. D. Ekpe, H.-J. Lee, and J.-E. Oh, “Perfluoroalkyl substances and pharmaceuticals removal in full-scale drinking water treatment plants,” Journal of Hazardous Materials, vol. 400, p. 123235, 2020 Dec. 5, 2020, doi: doi.org/10.1016/j.jhazmat.2020.123235.
[35] Y. Bao et al., “Removal of perfluorooctane sulfonate (PFOS) and perfluorooctanoate (PFOA) from water by coagulation: Mechanisms and influencing factors,” Journal of Colloid and Interface Science, vol. 434, pp. 59-64, 2014 Nov. 15, 2014, doi: doi.org/10.1016/j.jcis.2014.07.041.
[36] F. Xiao, M. F. Simcik, and J. S. Gulliver, “Mechanisms for removal of perfluorooctane sulfonate (PFOS) and perfluorooctanoate (PFOA) from drinking water by conventional and enhanced coagulation,” Water Research, vol. 47, no. 1, pp. 49-56, 2013 Jan. 1, 2013, doi: doi.org/10.1016/j.watres.2012.09.024.
[37] T. H. Boyer et al., “Anion exchange resin removal of per- and polyfluoroalkyl substances (PFAS) from impacted water: A critical review,” Water Research, vol. 200, p. 117244, 2021 Jul. 15, 2021, doi: doi.org/10.1016/j.watres.2021.117244.
[38] S. Woodard, M. G. Nickelsen, and M. M. Sinnett, “Ion Exchange for PFAS Removal,” in Perfluoroalkyl Substances in the Environment: CRC Press, 2018, pp. 325-352.
[39] T. D. Appleman et al., “Treatment of poly- and perfluoroalkyl substances in U.S. full-scale water treatment systems,” Water Research, vol. 51, pp. 246-255, 2014 Mar. 15, 2014, doi: doi.org/10.1016/j.watres.2013.10.067.
[40] A. Ndabigengesere and K. Subba Narasiah, “Quality of water treated by coagulation using Moringa oleifera seeds,” Water Research, vol. 32, no. 3, pp. 781-791, 1998 Mar. 1/1998, doi: doi.org/10.1016/S0043-1354 (97) 00295-9.
[41] T. Nkurunziza, J. B. Nduwayezu, E. N. Banadda, and I. Nhapi, “The effect of turbidity levels and Moringa oleifera concentration on the effectiveness of coagulation in water treatment,” Water Science and Technology, vol. 59, no. 8, pp. 1551-1558, 2009, doi: 10.2166/wst.2009.155.
[42] A. Ndabigengesere, K. S. Narasiah, and B. G. Talbot, “Active agents and mechanism of coagulation of turbid waters using Moringa oleifera,” Water Research, vol. 29, no. 2, pp. 703-710, 1995 Feb. 1/1995, doi: doi.org/10.1016/0043-1354 (94) 00161-Y.
[43] K. A. Ghebremichael, K. R. Gunaratna, H. Henriksson, H. Brumer, and G. Dalhammar, “A simple purification and activity assay of the coagulant protein from Moringa oleifera seed,” Water Research, vol. 39, no. 11, pp. 2338-2344, 2005 Jun. 1, 2005, doi: doi.org/10.1016/j.watres.2005.04.012.
[44] L. Samineni et al., “Effective pathogen removal in sustainable natural fiber Moringa filters,” npj Clean Water, vol. 5, no. 1, p. 27, 2022 Jul. 6 2022, doi: 10.1038/s41545-022-00170-5.
[45] M. D. Shortridge, D. S. Hage, G. S. Harbison, and R. Powers, “Estimating Protein-Ligand Binding Affinity Using High-Throughput Screening by NMR,” Journal of Combinatorial Chemistry, vol. 10, no. 6, pp. 948-958, 2008 Nov. 10 2008, doi: 10.1021/cc800122 m.
[46] O. Trott and A. J. Olson, “AutoDock Vina: Improving the speed and accuracy of docking with a new scoring function, efficient optimization, and multithreading,” Journal of Computational Chemistry, vol. 31, no. 2, pp. 455-461, 2010, doi: doi.org/10.1002/jcc.21334.
[47] G. M. Morris et al., “AutoDock4 and AutoDockTools4: Automated docking with selective receptor flexibility,” (in eng), J Comput Chem, vol. 30, no. 16, pp. 2785-91, December 2009, doi: 10.1002/jcc.21256.
[48] N. M. O'Boyle, M. Banck, C. A. James, C. Morley, T. Vandermeersch, and G. R. Hutchison, “Open Babel: An open chemical toolbox,” Journal of Cheminformatics, vol. 3, no. 1, p. 33, 2011 Oct. 7 2011, doi: 10.1186/1758-2946-3-33.
[49] Schrodinger, LLC, “The PyMOL Molecular Graphics System, Version 1.8,” November, 2015.
[50] J. M. Gifoni et al., “A novel chitin-binding protein from Moringa oleifera seed with potential for plant disease control,” Peptide Science, vol. 98, no. 4, pp. 406-415, 2012, doi: doi.org/10.1002/bip.22068.
[51] K. Shebek, A. B. Schantz, I. Sines, K. Lauser, S. Velegol, and M. Kumar, “The Flocculating Cationic Polypetide from Moringa oleifera Seeds Damages Bacterial Cell Membranes by Causing Membrane Fusion,” Langmuir, vol. 31, no. 15, pp. 4496-502, Apr. 21 2015, doi: 10.1021/acs.langmuir.5b00015.
[52] D. Fologea, B. Ledden, D. S. McNabb, and J. Li, “Electrical characterization of protein molecules by a solid-state nanopore,” (in eng), Appl Phys Lett, vol. 91, no. 5, pp. 539011-539013, Jul. 31 2007, doi: 10.1063/1.2767206.
[53] A. Steudle and J. Pleiss, “Modelling of lysozyme binding to a cation exchange surface at atomic detail: the role of flexibility,” (in eng), Biophys J, vol. 100, no. 12, pp. 3016-24, Jun. 22 2011, doi: 10.1016/j.bpj.2011.05.024.
[54] J. Sánchez-Martin, K. Ghebremichael, and J. Beltrán-Heredia, “Comparison of single-step and two-step purified coagulants from Moringa oleifera seed for turbidity and DOC removal,” Bioresource Technology, vol. 101, no. 15, pp. 6259-6261, 2010 Aug. 1, 2010, doi: doi.org/10.1016/j.biortech.2010.02.072.
[55] L. A. MacManus-Spencer, M. L. Tse, P. C. Hebert, H. N. Bischel, and R. G. Luthy, “Binding of Perfluorocarboxylates to Serum Albumin: A Comparison of Analytical Methods,” Analytical Chemistry, vol. 82, no. 3, pp. 974-981, 2010 Feb. 1 2010, doi: 10.1021/ac902238u.
[56] S. Maity, R. K. Gundampati, and T. K. Suresh Kumar, “NMR Methods to Characterize Protein-Ligand Interactions,” Natural Product Communications, vol. 14, no. 5, p. 1934578X19849296, 2019 May 1 2019, doi: 10.1177/1934578X19849296.
[57] M. Fedorenko, J. Alesio, A. Fedorenko, A. Slitt, and G. D. Bothun, “Dominant entropic binding of perfluoroalkyl substances (PFASs) to albumin protein revealed by 19F NMR,” Chemosphere, vol. 263, p. 128083, 2021 Jan. 1, 2021, doi: doi.org/10.1016/j.chemosphere.2020.128083.

The compositions, systems, devices, and methods of the appended claims are not limited in scope by the specific compositions, systems, devices, and methods described herein, which are intended as illustrations of a few aspects of the claims. Any compositions, systems, devices, and methods that are functionally equivalent are intended to fall within the scope of the claims. Various modifications of the compositions, systems, devices, and methods in addition to those shown and described herein are intended to fall within the scope of the appended claims. Further, while only certain representative compositions, systems, devices, and methods disclosed herein are specifically described, other combinations of the compositions, systems, devices, and methods also are intended to fall within the scope of the appended claims, even if not specifically recited. Thus, a combination of elements, components, or constituents may be explicitly mentioned herein or less, however, other combinations of elements, components, and constituents are included, even though not explicitly stated.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

1. A filter media comprising a hydrophobic fiber and a microbial binding material disposed thereon.

2. The media of claim 1, wherein the microbial binding material comprises a protein extracted from Moringa oleifera seeds.

3. The media of claim 2, wherein the protein comprises a cationic protein.

4. The media of claim 2, wherein the protein comprises Moringa oleifera chitin-binding protein (MOCBP), Moringa oleifera coagulant protein (MO2.1), isoforms thereof, or a combination thereof.

5. The media of claim 1, wherein the hydrophobic fiber is oleophilic.

6. The media of claim 1, wherein the hydrophobic fiber comprises a natural fiber.

7. The media of claim 1, the hydrophobic fiber comprises a natural fiber functionalized to increase oleophilicity.

8. The media of claim 1, the hydrophobic fiber comprises a synthetic fiber.

9. The media of claim 1, wherein the hydrophobic fiber comprises kapok fibers, silk fibers, milkweed fibers, polyolefin fibers, polyester fibers, or any combination thereof.

10. (canceled)

11. The media of claim 1, wherein the hydrophobic fiber comprises kapok fibers.

12. The media of claim 1, wherein the microbial binding material is disposed on the hydrophobic fiber in an amount of from 1 to 100 mg microbial binding material/g hydrophobic fiber.

13. The media of claim 1, wherein the hydrophobic fiber has an average fiber length from 5 to 100 mm.

14. (canceled)

15. The media of claim 1, wherein the hydrophobic fiber has an absorption capacity from 1 g oil/g fiber to 100 g oil/g fiber.

16. The media of claim 1, wherein the hydrophobic fiber has a water contact angle greater than 90 degrees.

17. The media of claim 1, wherein the microbial binding material is electrostatically disposed on the hydrophobic fiber, hydrophobically disposed on the hydrophobic fibers, or any combination thereof.

18. A filter comprising the filter media of claim 1 disposed within a housing.

19-24. (canceled)

25. A system for decreasing a concentration of a contaminant in a fluid, the system comprising:
a fluid source; and
a filtration unit comprising:
a fluid inlet fluidly connected to the fluid source;
a housing comprising the filter media of claim 1 disposed therewithin; and
a fluid outlet.

26-35. (canceled)

36. A method of decreasing a concentration of a contaminant in a fluid, the method comprising: passing the fluid through the filter media of claim 1.

37-48. (canceled)

49. A filter media for decreasing the concentration of a per- and polyfluoroalkyl substance (PFAS) in a fluid comprising:
a fibrous substrate and a cationic binder disposed thereon.

50-62. (canceled)

63. A method of decreasing a concentration of one or more PFAS in a fluid, the method comprising: passing the fluid through the filter media of claim 49.
